(19) United States
(12) Patent Application Publication
(10) Pub. No.: US 2012/0121824 A1
(43) Pub. Date: May 17, 2012

(54) PRESSURE-SENSITIVE ADHESIVE COMPOSITION FOR OPTICAL FILM, PRESSURE-SENSITIVE ADHESIVE LAYER FOR OPTICAL FILM, PRESSURE-SENSITIVE ADHESIVE OPTICAL FILM AND IMAGE DISPLAY

(75) Inventors: Yuusuke Toyama, Osaka (JP); Arata Fujihara, Osaka (JP); Akiko Sugino, Osaka (JP); Atsushi Yasui, Osaka (JP); Masayuki Satake, Osaka (JP); Mizue Nagata, Osaka (JP); Tomoyuki Kimura, Osaka (JP)

(73) Assignee: NITTO DENKO CORPORATION, Ibaraki-shi, Osaka (JP)

(21) Appl. No.: 13/266,946

(22) PCT Filed: Apr. 27, 2010
(86) PCT No.: PCT/JP2010/057488

§ 371 Date: Feb. 1, 2012

(30) Foreign Application Priority Data
Apr. 30, 2009 (JP) 2009-110917
Aug. 28, 2009 (JP) 2009-198457
Nov. 20, 2009 (JP) 2009-265543

(51) Int. Cl. G02B 5/00; B32B 27/30; C09J 171/08; C09J 7/02

(52) U.S. Cl. 428/1.52; 428/355 AC; 428/354; 524/506

(57) ABSTRACT

A pressure-sensitive adhesive composition for an optical film of the present invention comprises a (meth)acryl-based polymer (A): and a polyether compound (B) having a polyether skeleton and a reactive silyl group represented by formula (1): —SiRₐM₃₋ₐ at at least one terminal, wherein R represents a monovalent organic group having 1 to 20 carbon atoms and optionally having a substituent; M represents a hydroxyl group or a hydrolyzable group; and <a> represents an integer of 1 to 3, provided that in cases where two or more R groups, R groups is the same or different, and in cases where two or more M groups, M groups is the same or different. The pressure-sensitive adhesive composition for an optical film is capable of forming a pressure-sensitive adhesive layer having reworkability that enables an optical film to be easily peeled off from a liquid crystal panel or the like with no adhesive residue and satisfactory durability that prevents a bonded optical film from peeling or lifting.

### TECHNICAL FIELD

The present invention relates to a pressure-sensitive adhesive composition excellent in re-peelability (reworkability) and excellent in adhesion state for an optical film, and a pressure-sensitive adhesive optical film including an optical film and a pressure-sensitive adhesive layer formed on at least one side of the optical film. The present invention further relates to an image display such as a liquid crystal display and an organic electroluminescence (EL) display, including the pressure-sensitive adhesive optical film. The optical film may be a polarizing plate, a retardation plate, an optical compensation film, a brightness enhancement film, a laminate thereof, or the like.

### BACKGROUND ART

The image-forming system of liquid crystal displays or the like requires polarizing elements to be placed on both sides of a liquid crystal cell, and generally polarizing plates are bonded thereto. Besides polarizing plates, a variety of optical elements have been used for liquid crystal panels to improve display quality. For example, there are used retardation plates for prevention of discoloration, viewing angle expansion films for improvement of the viewing angle of liquid crystal displays, and brightness enhancement films for enhancement of the contrast of displays. These films are generically called optical films.

When the optical members such as optical films are bonded to a liquid crystal cell, pressure-sensitive adhesives are generally used. Bonding between an optical film and a liquid crystal cell or between optical films is generally performed with a pressure-sensitive adhesive in order to reduce optical loss. In such a case, a pressure-sensitive adhesive optical film including an optical film and a pressure-sensitive adhesive layer previously formed on one side of the optical film is generally used, because it has some advantages such as no need for a drying process to fix the optical film.

The pressure-sensitive adhesive is required to have some properties. In some cases, for example, if in the process of attaching an optical film to a liquid crystal cell, they are misaligned or foreign matter is caught on the attaching surface, the optical film should be separated from the liquid crystal panel so that the liquid crystal cell can be reused. For this separation process, the pressure-sensitive adhesive is required to have re-peelability (reworkability) so that the optical film can be easily peeled off from the liquid crystal panel with no adhesive residue. Particularly in recent years, thin liquid crystal panels produced with chemically-etched glass plates are frequently used together with conventional panel manufacturing processes, and it has become difficult to ensure the reworkability or processability of optical films from such thin liquid crystal panels. The pressure-sensitive adhesive is also required to have workability that it can be worked without fouling or dropout after a pressure-sensitive adhesive layer is formed on an optical film, and such properties that it does not cause a problem such as peeling or separation in a durability test by heating, humidifying or the like, which is generally performed as an environmental acceleration test.

In addition to reworkability, pressure-sensitive adhesives for optical films are required to have the ability to suppress display non-uniformity (such as peripheral non-uniformity or corner non-uniformity) caused by a white spot at a peripheral portion. It is proposed that such pressure-sensitive adhesives for optical films should contain an acrylic resin (1) with a weight average molecular weight of 1,000,000 to 2,000,000, an acrylic resin (2) with a weight average molecular weight of 50,000 to 500,000, a silicone oligomer (3), and a crosslinking agent (4) (Patent Document 1). There is also proposed a pressure-sensitive adhesive composition containing: 100 parts of a copolymer (A) with a weight average molecular weight of 1,000,000 to 2,000,000 obtained by polymerization of a reactive functional group-containing monomer (a) and a monomer (b) copolymerizable with the monomer (a); 20 to 150 parts of a copolymer (B) with a weight average molecular weight of 10,000 to 100,000 obtained by polymerization of monomers (c) and (d) in the presence of the copolymer (A); 0.1 to 10 parts of a polyol (C) that has a degree of polymerization of 3 or more and is liquid at 25° C.; and 0.003 to 3 parts of a polyfunctional compound (D) (Patent Document 2).

In addition to reworkability, pressure-sensitive adhesives for optical films are also required to have durability in the bonded state. It is proposed that such pressure-sensitive adhesives for optical films should be acryl-based pressure-sensitive adhesive compositions typically containing: a) 100 parts by weight of an acryl-based copolymer containing a hydroxy group but not containing any carboxyl group; b) 0.01 to 10 parts by weight of a crosslinking agent; and c) 0.01 to 5.0 parts by weight of a polyether-modified polydimethylsiloxane copolymer with an HLB value of 4 to 13 (Patent Document 3). There is also proposed a pressure-sensitive adhesive composition containing: an acryl-based oligomer-type silane coupling agent (A) obtained by copolymerization of a silane compound (a) having a polymerizable double bond group and an alkoxy group, a functional group-containing monomer (b), and a non-functional alkyl (meth)acrylate monomer (c); and an acryl-based copolymer (B) other than the silane coupling agent (A); and a crosslinking agent (C) (Patent Document 4).

As described above, pressure-sensitive adhesives for optical films are required to have the ability to suppress display non-uniformity (such as peripheral non-uniformity or corner non-uniformity) caused by a white spot at a peripheral portion and to have improved durability, in addition to reworkability, and there has been a demand for a pressure-sensitive adhesive composition capable of achieving improvements in the above properties.

### PRIOR ART DOCUMENTS

### Patent Documents

Patent Document 1: JP-A No. 2006-316256
Patent Document 2: JP-A No. 2008-044984
Patent Document 3: JP-A No. 2008-503638
Patent Document 4: JP-A No. 2008-101168

### SUMMARY OF THE INVENTION

### Problems to be Solved by the Invention

An object of the present invention is to provide a pressure-sensitive adhesive composition for optical films, which is capable of forming a pressure-sensitive adhesive layer having: reworkability that enables an optical film to be easily peeled off from a liquid crystal panel or the like with no adhesive residue; and satisfactory durability that prevents a bonded optical film from peeling or lifting.

Another object of the present invention is to provide a pressure-sensitive adhesive composition for optical films, which is capable of forming a pressure-sensitive adhesive layer having: reworkability that enables an optical film to be easily peeled off from a liquid crystal panel or the like with no adhesive residue; satisfactory durability that prevents a bonded optical film from peeling or lifting; and the ability to suppress display non-uniformity caused by a white spot at a peripheral portion.

An object of the present invention is also to provide a pressure-sensitive adhesive layer formed from the pressure-sensitive adhesive composition for an optical film, and a further object of the present invention is to provide a pressure-sensitive adhesive optical film including such a pressure-sensitive adhesive layer and to provide an image display including such a pressure-sensitive adhesive optical film.

As a result of investigations for solving the problems, the inventors have found the pressure-sensitive adhesive composition for an optical film described below and have completed the present invention.

The present invention relates to a pressure-sensitive adhesive composition for an optical film, including:

a (meth)acryl-based polymer (A): and

a polyether compound (B) having a polyether skeleton and a reactive silyl group represented by formula (1): —SiRₐM₃₋ₐ at at least one terminal,

wherein R represents a monovalent organic group having 1 to 20 carbon atoms and optionally having a substituent; M represents a hydroxyl group or a hydrolyzable group; and <a> represents an integer of 1 to 3, provided that in cases where two or more R groups, R groups is the same or different, and in cases where two or more M groups, M groups is the same or different.

In the pressure-sensitive adhesive composition for an optical film, the polyether skeleton of the polyether compound (B) preferably includes straight- or branched-chain oxyalkylene group of 1 to 10 carbon atoms as a repeating structural unit.

In the pressure-sensitive adhesive composition for an optical film, the polyether compound (B) is preferably a compound represented by formula (2): RₐM₃₋ₐSi—X—Y-(AO)ₙ—Z,

wherein R represents a monovalent organic group having 1 to 20 carbon atoms and optionally having a substituent; M represents a hydroxyl group or a hydrolyzable group; <a> represents an integer of 1 to 3, provided that in cases where two or more R groups, R groups is the same or different, and in cases where two or more M groups, M groups is the same or different; AO represents a straight- or branched-chain oxyalkylene group of 1 to 10 carbon atoms; n represents the average addition molar number of the oxyalkylene groups, which is from 1 to 1,700; X represents a straight- or branched-chain alkylene group of 1 to 20 carbon atoms; Y represents an ether bond, an ester bond, a urethane bond, or a carbonate bond and

Z represents a hydrogen atom, a monovalent hydrocarbon group of 1 to 10 carbon atoms,

a group represented by formula (2A): —Y¹—X—SiRₐM₃₋ₐ,

wherein R, M and X have the same meanings as defined above; and Y¹ represents a single bond, a —CO— bond, a —CONH— bond, or a —COO— bond, or

a group represented by formula (2B): -Q{-(OA)ₙ-Y—X—SiRₐM₃₋ₐ}ₘ,

wherein R, M, X, and Y have the same meanings as defined above, OA has the same meaning as AO defined above, n has the same meaning as defined above, Q represents a divalent or polyvalent hydrocarbon group of 1 to 10 carbon atoms, and m represents a number that is the same as the valence of the hydrocarbon group.

In The pressure-sensitive adhesive composition for an optical film, the reactive silyl group of the polyether compound (B) is preferably an alkoxysilyl group represented by formula (3):

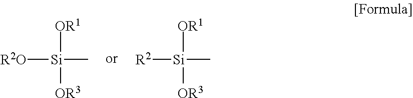

wherein R¹, R² and R³ each represent a monovalent hydrocarbon group of 1 to 6 carbon atoms and is the same or different in the same molecule.

In the pressure-sensitive adhesive composition for an optical film, the polyether compound (B) is, among the compound represented by formula (2), preferably a compound represented by formula (4): Z⁰-A²-O-(A¹O)ₙ—Z¹,

wherein A¹O represents an oxyalkylene group of 2 to 6 carbon atoms; n represents the average addition molar number of A¹O, which is from 1 to 1,700; Z¹ represents a hydrogen atom or -A²-Z⁰; and A² represents an alkylene group of 2 to 6 carbon atoms,

wherein Z⁰ represents an alkoxysilyl group represented by formula (3):

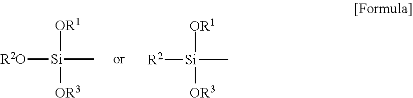

wherein R¹, R² and R³ each represent a monovalent hydrocarbon group of 1 to 6 carbon atoms and is the same or different in the same molecule.

In the pressure-sensitive adhesive composition for an optical film, the polyether compound (B) is, among the compound represented by formula (2), also preferably a compound represented by formula (5): Z⁰-A²-NHCOO-(A¹O)ₙ—Z²,

wherein A¹O represents an oxyalkylene group of 2 to 6 carbon atoms; n represents the average addition molar number of A¹O, which is from 1 to 1,700; Z² represents a hydrogen atom or —CONH-A²-Z⁰; and A² represents an alkylene group of 2 to 6 carbon atoms, wherein Z⁰ represents an alkoxysilyl group represented by formula (3):

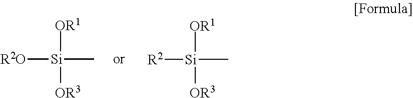

wherein R¹, R² and R³ each represent a monovalent hydrocarbon group of 1 to 6 carbon atoms and is the same or different in the same molecule.

In the pressure-sensitive adhesive composition for an optical film, the polyether compound (B) is, among the compound represented by formula (2), also preferably a compound represented by formula (6): Z³—O-(A¹O)ₙ—C{—CH₂-(A¹O)ₙ—Z³}₂,

wherein A¹O represents an oxyalkylene group of 2 to 6 carbon atoms; n represents the average addition molar number of A¹O, which is from 1 to 1,700; Z³ represents a hydrogen atom or -A²-Z⁰ and at least one of the Z³ groups is -A-Z⁰, and A² represents an alkylene group of 2 to 6 carbon atoms,

wherein Z⁰ represents is an alkoxysilyl group represented by formula (3):

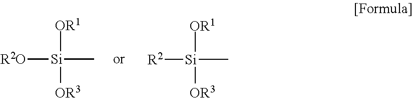

wherein R¹, R² and R³ each represent a monovalent hydrocarbon group of 1 to 6 carbon atoms and is the same or different in the same molecule.

In the pressure-sensitive adhesive composition for an optical film, the polyether compound (B) preferably has a number average molecular weight of 300 to 100,000.

In the pressure-sensitive adhesive composition for an optical film, it is preferable to includes 0.001 to 20 parts by weight of the polyether compound (B) based on 100 parts by weight of the (meth)acryl-based polymer (A).

In the pressure-sensitive adhesive composition for an optical film, it is preferable to use the (meth)acryl-based polymer (A) including an alkyl (meth)acrylate monomer unit and a hydroxyl group-containing monomer unit.

The pressure-sensitive adhesive composition for an optical film, it is preferable to use the (meth)acryl-based polymer (A) including an alkyl (meth)acrylate monomer unit and a carboxyl group-containing monomer unit.

In the pressure-sensitive adhesive composition for an optical film, it is preferable to use the (meth)acryl-based polymer (A) including a (meth)acryl-based polymer (A′) including an alkyl (meth)acrylate monomer unit and a polymerizable aromatic ring-containing monomer unit.

The (meth)acryl-based polymer (A′) preferably includes 1 to 50% by weight of the polymerizable aromatic ring-containing monomer unit.

It is preferable to use the (meth)acryl-based polymer (A′) further including a hydroxyl group-containing monomer unit.

It is preferable to use the (meth)acryl-based polymer (A′) further including a carboxyl group-containing monomer unit.

The pressure-sensitive adhesive composition for an optical film further may include a crosslinking agent. In the pressure-sensitive adhesive composition for an optical film, it is preferable to include 0.01 to 20 parts by weight of the crosslinking agent (C) based on 100 parts by weight of the (meth)acryl-based polymer (A). The crosslinking agent (C) is preferably at least one selected from an isocyanate compound and a peroxide.

The pressure-sensitive adhesive composition for an optical film may further include 0.001 to 5 parts by weight of a silane coupling agent (D) based on 100 parts by weight of the (meth)acryl-based polymer (A).

In the pressure-sensitive adhesive composition for an optical film, the (meth)acryl-based polymer (A) preferably has a weight average molecular weight of 500,000 to 4,000,000.

The present invention also relates to a pressure-sensitive adhesive layer for an optical film, including a product formed from the pressure-sensitive adhesive composition for an optical film.

The present invention also relates to a pressure-sensitive adhesive optical film, including an optical film; and the pressure-sensitive adhesive layer for an optical film formed on at least one side of the optical film. The pressure-sensitive adhesive optical film further may include an adhesion-facilitating layer that is provided between the optical film and the pressure-sensitive adhesive layer for an optical film.

The present invention also relates to an image display, including at least one piece of the pressure-sensitive adhesive optical film.

### Effects of the Invention

The pressure-sensitive adhesive composition for an optical film of the present invention contains a (meth)acryl-based polymer (A) as a base polymer and a polyether compound (B) having a polyether skeleton and a reactive silyl group at least one terminal. A pressure-sensitive adhesive optical film can have a pressure-sensitive adhesive layer produced from the optical film pressure-sensitive adhesive composition of the present invention, in which the pressure-sensitive adhesive layer contains the polyether compound (B), so that even when the pressure-sensitive adhesive optical film bonded to a liquid crystal cell or the like goes through a long time by undergoing various processes or is stored at high temperature, the adhesive strength to the liquid crystal cell or the like does not increase, and therefore, the pressure-sensitive adhesive optical film can be easily peeled off from the liquid crystal cell or the like with good reworkability and without damage to or fouling of the liquid crystal cell, so that the liquid crystal cell can be reused. In particular, it has been difficult to peel off pressure-sensitive adhesive optical films from large liquid crystal cells, but according to the present invention, pressure-sensitive adhesive optical films can also be easily peeled off from large liquid crystal cells. The pressure-sensitive adhesive optical film of the present invention also has good durability, so that the optical film bonded to a liquid crystal cell or the like can be prevented from peeling or lifting.

The (meth)acryl-based polymer (A) may be a (meth)acryl-based polymer (A′) including an alkyl (meth)acrylate monomer unit and a polymerizable aromatic ring-containing monomer unit. In this case, the pressure-sensitive adhesive optical film of the present invention provides good durability for a variety of optical films (such as triacetylcellulose-based resin, (meth)acryl-based resin, or norbornene-based resin films), and the optical film bonded to a liquid crystal cell or the like can be prevented from peeling or lifting.

When the (meth)acryl-based polymer (A) is the (meth)acryl-based polymer (A′), the advantageous effects described below are produced. Specifically, if an image display such as a liquid crystal display produced with a pressure-sensitive adhesive optical film such as a pressure-sensitive adhesive polarizing plate is exposed to heat or humid conditions, display non-uniformity such as peripheral non-uniformity or corner non-uniformity may be caused by a white spot at a peripheral portion of a liquid crystal panel or the like, so that display defects may occur. In contrast, the pressure-sensitive adhesive layer of the pressure-sensitive adhesive optical film of the present invention, which is produced using the optical film pressure-sensitive adhesive composition, can suppress the occurrence of display non-uniformity at the peripheral portion of the display screen. It is considered that when the (meth)acryl-based polymer (A), a base polymer in the optical film pressure-sensitive adhesive composition of the present invention, contains a polymerizable aromatic ring-containing monomer unit in addition to an alkyl (meth)acrylate monomer unit, the polymerizable aromatic ring-containing monomer unit can suppress the occurrence of display non-uniformity at the peripheral portion.

### EMBODIMENTS FOR CARRYING OUT THE INVENTION

The pressure-sensitive adhesive composition for an optical film of the present invention contains a (meth)acryl-based polymer (A) as a base polymer. The (meth)acryl-based polymer (A) includes an alkyl (meth)acrylate monomer unit as a main component. The term “(meth)acrylate” refers to acrylate and/or methacrylate, and “(meth)” is used in the same meaning in the description.

The alkyl (meth)acrylate used to form the main skeleton of the (meth)acrylic polymer (A) may have a straight- or branched-chain alkyl group of 1 to 18 carbon atoms. Examples of such an alkyl group include methyl, ethyl, propyl, isopropyl, butyl, isobutyl, amyl, hexyl, cyclohexyl, heptyl, 2-ethylhexyl, isooctyl, nonyl, decyl, isodecyl, dodecyl, isomyristyl, lauryl, tridecyl, pentadecyl, hexadecyl, heptadecyl, and octadecyl groups. These may be used singly or in any combination. The average number of carbon atoms in the alkyl group is preferably from 3 to 9.

An aromatic ring-containing alkyl (meth)acrylate such as phenoxyethyl (meth)acrylate may also be used. A polymer obtained by polymerizing the aromatic ring-containing alkyl (meth)acrylate may be used in a mixture with any of the above examples of the (meth)acryl-based polymer. In view of transparency, however, a copolymer obtained by polymerizing the aromatic ring-containing alkyl (meth)acrylate and the above alkyl (meth)acrylate is preferably used.

In order to improve tackiness or heat resistance, one or more copolymerizable monomers having an unsaturated double bond-containing polymerizable functional group such as a (meth)acryloyl group or a vinyl group may be introduced into the (meth)acryl-based polymer (A) by copolymerization. Examples of such copolymerizable monomers include hydroxyl group-containing monomers such as 2-hydroxyethyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and (4-hydroxymethylcyclohexyl)-methyl acrylate; carboxyl group-containing monomers such as (meth)acrylic acid, carboxyethyl (meth)acrylate, carboxypentyl (meth)acrylate, itaconic acid, maleic acid, fumaric acid, and crotonic acid; acid anhydride group-containing monomers such as maleic anhydride and itaconic anhydride; caprolactone adducts of acrylic acid; sulfonic acid group-containing monomers such as styrenesulfonic acid, allylsulfonic acid, 2-(meth)acrylamido-2-methylpropanesulfonic acid, (meth) acrylamidopropanesulfonic acid, sulfopropyl (meth)acrylate, and (meth) acryloyloxynaphthalenesulfonic acid; and phosphate group-containing monomers such as 2-hydroxyethylacryloyl phosphate.

Examples of such a monomer for modification also include (N-substituted) amide monomers such as (meth)acrylamide, N,N-dimethyl(meth)acrylamide, N-butyl(meth)acrylamide, N-methylol(meth)acrylamide, and N-methylolpropane(meth)acrylamide; alkylaminoalkyl (meth)acrylate monomers such as aminoethyl (meth)acrylate, N,N-dimethylaminoethyl(meth)acrylate, and tert-butylaminoethyl (meth)acrylate; alkoxyalkyl (meth)acrylate monomers such as methoxyethyl (meth)acrylate and ethoxyethyl (meth)acrylate; succinimide monomers such as N-(meth) acryloyloxymethylenesuccinimide, N-(meth)acryloyl-6-oxyhexamethylenesuccinimide, N-(meth)acryloyl-8-oxyoctamethylenesuccinimide, and N-acryloylmorpholine; maleimide monomers such as N-cyclohexylmaleimide, N-isopropylmaleimide, N-laurylmaleimide, and N-phenylmaleimide; and itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide.

Examples of modification monomers that may also be used include vinyl monomers such as vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxylic acid amides, styrene, α-methylstyrene, and N-vinylcaprolactam; cyanoacrylate monomers such as acrylonitrile and methacrylonitrile; epoxy group-containing acrylic monomers such as glycidyl (meth)acrylate; glycol acrylic ester monomers such as polyethylene glycol (meth)acrylate, polypropylene glycol (meth)acrylate, methoxyethylene glycol (meth)acrylate, and methoxypolypropylene glycol (meth)acrylate; and acrylate ester monomers such as tetrahydrofurfuryl (meth)acrylate, fluoro(meth)acrylate, silicone (meth)acrylate, and 2-methoxyethyl acrylate. Examples also include isoprene, butadiene, isobutylene, and vinyl ether.

Besides the above, a silicon atom-containing silane monomer may be exemplified as the copolymerizable monomer. Examples of the silane monomers include 3-acryloxypropyltriethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyltriethoxysilane, and 10-acryloyloxydecyltriethoxysilane.

Copolymerizable monomers that may be used also include polyfunctional monomers having two or more unsaturated double bonds such as (meth)acryloyl groups or vinyl groups, which include (meth)acrylate esters of polyhydric alcohols, such as tripropylene glycol di(meth)acrylate, tetraethylene glycol di(meth)acrylate, 1,6-hexanediol di(meth)acrylate, bisphenol A diglycidyl ether di(meth)acrylate, neopentyl glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, and caprolactone-modified dipentaerythritol hexa(meth)acrylate; and compounds having a polyester, epoxy or urethane skeleton to which two or more unsaturated double bonds are added in the form of functional groups such as (meth)acryloyl groups or vinyl groups in the same manner as the monomer component, such as polyester (meth)acrylates, epoxy (meth)acrylates and urethane (meth)acrylates.

Concerning the weight ratios of all monomer components, the alkyl (meth)acrylate should be a main component of the (meth)acryl-based polymer (A), and the content of the copolymerizable monomer used to form the (meth)acryl-based polymer (A) is preferably, but not limited to, 0 to about 20%, more preferably about 0.1 to about 15%, even more preferably about 0.1 to about 10%, based on the total weight of all monomer components.

Among these copolymerizable monomers, hydroxyl group-containing monomers or carboxyl group-containing monomers are preferably used in view of tackiness or durability. The hydroxyl group-containing monomer may be used in combination with the carboxyl group-containing monomer. When the pressure-sensitive adhesive composition contains a crosslinking agent, these copolymerizable monomers can serve as a reactive site with the crosslinking agent. Such hydroxyl group-containing monomers or carboxyl group-containing monomers are highly reactive with intermolecular crosslinking agents and therefore are preferably used to improve the cohesiveness or heat resistance of the resulting pressure-sensitive adhesive layer. Hydroxyl group-containing monomers are preferred in terms of reworkability, and carboxyl group-containing monomers are preferred in terms of achieving both durability and reworkability.

When a hydroxyl group-containing monomer is added as a copolymerizable monomer, its content is preferably from 0.01 to 2% by weight, more preferably from 0.03 to 1.5% by weight, even more preferably from 0.05 to 1% by weight. When a carboxyl group-containing monomer is added as a copolymerizable monomer, its content is preferably from 0.1 to 10% by weight, more preferably from 0.2 to 8% by weight, even more preferably from 0.6 to 6% by weight.

The (meth)acryl-based polymer (A) which includes an alkyl (meth)acrylate monomer unit and a polymerizable aromatic ring-containing monomer unit, is preferably used. Hereinafter, this type of (meth)acryl-based polymer (A) is specifically referred to as the (meth)acryl-based polymer (A′).

In order to ensure adhesive property and the like, the content of the alkyl (meth)acrylate in the (meth)acryl-based polymer (A′) is preferably 40% by weight or more, more preferably 50% by weight or more, even more preferably 60% by weight or more, still more preferably 70% by weight or more, yet more preferably 80% by weight or more, based on the weight of all monomer components (100% by weight) of the (meth)acryl-based polymer (A′) including the alkyl (meth)acrylate, the polymerizable aromatic ring-containing monomer, and the copolymerizable monomer described below.

The polymerizable aromatic ring-containing monomer is a compound containing an aromatic group in the structure and having a polymerizable unsaturated double bond group such as a (meth)acryloyl group or a vinyl group. The aromatic group may be a benzene ring, a naphthalene ring, a biphenyl ring, a heterocyclic ring, or the like. The heterocyclic ring may be a morpholine ring, a piperidine ring, a pyrrolidine ring, a piperazine ring, or the like. For example, the compound may be an aromatic group-containing (meth)acrylate.

Examples of the aromatic group-containing (meth)acrylate include a benzene ring-containing (meth)acrylate such as benzyl (meth)acrylate, phenyl (meth)acrylate, o-phenylphenol (meth)acrylate, phenoxy (meth)acrylate, phenoxyethyl (meth)acrylate, phenoxypropyl (meth)acrylate, phenoxydiethylene glycol (meth)acrylate, ethylene oxide-modified nonyl phenol (meth)acrylate, ethylene oxide-modified cresol (meth)acrylate, phenolethylene oxide-modified (meth)acrylate, 2-hydroxy-3-phenoxypropyl(meth)acrylate, methoxybenzyl (meth)acrylate, chlorobenzyl (meth)acrylate, cresyl (meth)acrylate, or polystyryl (meth)acrylate; a naphthalene ring-containing (meth)acrylate such as hydroxyethylated β-naphthol acrylate, 2-naphthoethyl (meth)acrylate, 2-naphthoxyethyl acrylate, or 2-(4-methoxy-1-naphthoxy)ethyl(meth)acrylate; and a biphenyl ring-containing (meth)acrylate such as biphenyl (meth)acrylate.

Examples of the heterocyclic ring-containing (meth)acrylate include thiol (meth)acrylate, pyridyl (meth)acrylate, and pyrrole (meth)acrylate. Other heterocyclic ring-containing (meth)acrylic monomers include N-acryloylmorpholine, N-acryloylpiperidine, N-methacryloylpiperidine, and N-acryloylpyrrolidine.

Examples of the aromatic group-containing vinyl compound include vinylpyridine, vinylpiperidone, vinylpyrimidine, vinylpiperazine, vinylpyrazine, vinylpyrrole, vinylimidazole, vinyloxazole, vinylmorpholine, N-vinylcarboxylic acid amides, styrene, and α-methylstyrene.

The polymerizable aromatic ring-containing monomer may also have a sulfonic acid group or any other functional group in addition to the polymerizable unsaturated double bond group such as a (meth)acryloyl group or a vinyl group. Examples of the polymerizable aromatic ring-containing monomer having such a functional group include styrenesulfonic acid and (meth) acryloyloxynaphthalenesulfonic acid.

In view of adhesive properties or durability, the polymerizable aromatic ring-containing monomer is preferably an aromatic group-containing (meth)acrylate, specifically, benzyl (meth)acrylate or phenoxyethyl (meth)acrylate, and benzyl (meth)acrylate is particularly preferred.

The content of the polymerizable aromatic ring-containing monomer in the (meth)acryl-based polymer (A′) is preferably from 1 to 50% by weight, based on the weight of all monomer components (100% by weight) of the (meth)acryl-based polymer (A′). The content of the polymerizable aromatic ring-containing monomer is more preferably from 1 to 35% by weight, even more preferably from 1 to 20% by weight, still more preferably from 7 to 18% by weight, yet more preferably from 10 to 16% by weight.

The copolymerizable monomer(s) described above for the (meth)acryl-based polymer (A) may also be used to form the (meth)acryl-based polymer (A′).

The content of the copolymerizable monomer(s) in the (meth)acryl-based polymer (A′) is preferably from 0 to about 20% by weight, more preferably from about 0.1 to about 15% by weight, even more preferably from about 0.1 to about 10% by weight, based on the weight of all monomer components (100% by weight) of the (meth)acryl-based polymer (A′) including the alkyl (meth)acrylate and the polymerizable aromatic ring-containing monomer.

Among these copolymerizable monomers, hydroxyl group-containing monomers or carboxyl group-containing monomers are preferably used in view of tackiness or durability. The hydroxyl group-containing monomer may be used in combination with the carboxyl group-containing monomer. When the pressure-sensitive adhesive composition contains a crosslinking agent, these copolymerizable monomers can serve as a reactive site with the crosslinking agent. Such hydroxyl group-containing monomers or carboxyl group-containing monomers are highly reactive with intermolecular crosslinking agents and therefore are preferably used to improve the cohesiveness or heat resistance of the resulting pressure-sensitive adhesive layer. Hydroxyl group-containing monomers are preferred in terms of reworkability, and carboxyl group-containing monomers are preferred in terms of achieving both durability and reworkability.

When a hydroxyl group-containing monomer is added as a copolymerizable monomer, its content is preferably from 0.01 to 2% by weight, more preferably from 0.03 to 1.5% by weight, even more preferably from 0.05 to 1% by weight. When a carboxyl group-containing monomer is added as a copolymerizable monomer, its content is preferably from 0.1 to 10% by weight, more preferably from 0.2 to 8% by weight, even more preferably from 0.6 to 6% by weight.

In an embodiment of the present invention, the (meth)acryl-based polymer (A) used generally has a weight average molecular weight in the range of 500,000 to 4,000,000. In view of durability, particularly in view of heat resistance, the weight average molecular weight of the polymer (A) used is preferably from 800,000 to 3,000,000, more preferably from 1,400,000 to 2,700,000, even more preferably from 1,700,000 to 2,500,000, still more preferably from 1,800,000 to 2,400,000. If the weight average molecular weight is less than 500,000, it is not preferred in view of heat resistance. If the weight average molecular weight is more than 4,000,000, the bonding ability or adhesive strength may also be undesirably reduced. The weight average molecular weight refers to the value obtained by measurement by gel permeation chromatography (GPC) and conversion of the measured value into the polystyrene-equivalent value.

For the production of the (meth)acrylic polymer (A), any appropriate method may be selected from known production methods such as solution polymerization, bulk polymerization, emulsion polymerization, and various radical polymerization methods. The resulting (meth)acrylic polymer (A) may be any type of copolymer such as a random copolymer, a block copolymer and a graft copolymer.

In a solution polymerization process, for example, ethyl acetate, toluene or the like is used as a polymerization solvent. In a specific solution polymerization process, for example, the reaction is performed under a stream of inert gas such as nitrogen at a temperature of about 50 to about 70° C. for about 5 to about 30 hours in the presence of a polymerization initiator.

Any appropriate polymerization initiator, chain transfer agent, emulsifying agent and so on may be selected and used for radical polymerization. The weight average molecular weight of the (meth)acrylic polymer (A) may be controlled by the reaction conditions including the amount of addition of the polymerization initiator or the chain transfer agent and monomers concentration. The amount of the addition may be controlled as appropriate depending on the type of these materials.

Examples of the polymerization initiator include, but are not limited to, azo initiators such as 2,2′-azobisisobutylonitrile, 2,2′-azobis(2-amidinopropane)dihydrochloride, 2,2′-azobis[2-(5-methyl-2-imidazoline-2-yl)propane]dihydrochloride, 2,2′-azobis(2-methylpropionamidine)disulfate, 2,2′-azobis(N,N′-dimethyleneisobutylamidine), and 2,2′-azobis[N-(2-carboxyethyl)-2-methylpropionamidine]hydrate (VA-057, manufactured by Wako Pure Chemical Industries, Ltd.); persulfates such as potassium persulfate and ammonium persulfate; peroxide initiators such as di(2-ethylhexyl)peroxydicarbonate, di(4-tert-butylcyclohexyl)peroxydicarbonate, di-sec-butylperoxydicarbonate, tert-butylperoxyneodecanoate, tert-hexylperoxypivalate, tert-butylperoxypivalate, dilauroyl peroxide, di-n-octanoyl peroxide, 1,1,3,3-tetramethylbutylperoxy-2-ethyl hexanoate, di(4-methylbenzoyl) peroxide, dibenzoyl peroxide, tert-butylperoxyisobutylate, 1,1-di(tert-hexylperoxy)cyclohexane, tert-butylhydroperoxide, and hydrogen peroxide; and redox system initiators of a combination of a peroxide and a reducing agent, such as a combination of a persulfate and sodium hydrogen sulfite and a combination of a peroxide and sodium ascorbate.

One of the above polymerization initiators may be used alone, or two or more thereof may be used in a mixture. The total content of the polymerization initiator is preferably from about 0.005 to 1 part by weight, more preferably from about 0.02 to about 0.5 parts by weight, based on 100 parts by weight of the monomer.

For example, when 2,2′-azobisisobutyronitrile is used as a polymerization initiator for the production of the (meth)acrylic polymer with the above weight average molecular weight, the polymerization initiator is preferably used in a content of from about 0.06 to 0.2 parts by weight, more preferably of from about 0.08 to 0.175 parts by weight, based on 100 parts by weight of the total content of the monomer components.

Examples of the chain transfer agent include lauryl mercaptan, glycidyl mercaptan, mercaptoacetic acid, 2-mercaptoethanol, thioglycolic acid, 2-ethylhexyl thioglycolate, and 2,3-dimercapto-1-propanol. One of these chain transfer agents may be used alone, or two or more thereof may be used in a mixture. The total content of the chain transfer agent is preferably 0.1 parts by weight or less, based on 100 parts by weight of the total content of the monomer components.

Examples of the emulsifier used in emulsion polymerization include anionic emulsifiers such as sodium lauryl sulfate, ammonium lauryl sulfate, sodium dodecylbenzenesulfonate, ammonium polyoxyethylene alkyl ether sulfate, and sodium polyoxyethylene alkyl phenyl ether sulfate; and nonionic emulsifiers such as polyoxyethylene alkyl ether, polyoxyethylene alkyl phenyl ether, polyoxyethylene fatty acid ester, and polyoxyethylene-polyoxypropylene block polymers. These emulsifiers may be used alone, or two or more thereof may be used in combination.

The emulsifier may be a reactive emulsifier. Examples of such an emulsifier having an introduced radical-polymerizable functional group such as a propenyl group and an allyl ether group include Aqualon HS-10, HS-20, KH-10, BC-05, BC-10, and BC-20 (each manufactured by Dai-ichi Kogyo Seiyaku Co., Ltd.) and Adekaria Soap SE10N (manufactured by Asahi Denka Kogyo K.K.). The reactive emulsifier is preferred, because after polymerization, it can be incorporated into a polymer chain to improve water resistance. Based on 100 parts by weight of the total monomer component, the emulsifier is preferably used in a content of 0.3 to 5 parts by weight, more preferably of 0.5 to 1 parts by weight, in view of polymerization stability or mechanical stability.

The pressure-sensitive adhesive composition of the present invention contains the polyether compound (B) in addition to the (meth)acryl-based polymer (A).

The polyether compound (B) having a polyether skeleton and a reactive silyl group represented by formula (1): —SiRₐM₃₋ₐ, at at least one terminal,

wherein R represents a monovalent organic group having 1 to 20 carbon atoms and optionally having a substituent; M represents a hydroxyl group or a hydrolyzable group, and <a> represents an integer of 1 to 3, provided that in cases where two or more R groups, R groups is the same or different, and in cases where two or more M groups, M groups is the same or different.

The polyether compound (B) has at least one reactive silyl group of the above formula in one molecule at the terminal. When the polyether compound (B) is a straight-chain compound, said polyether compound (B) can have one or two reactive silyl groups of the above formula at the terminals and preferably has two at the terminals. When the polyether compound (B) is a branched-chain compound, its terminals include the terminals of the main chain and the branched chain(s), and it has at least one reactive silyl group of the above formula at the terminal, and preferably has two or more, more preferably three or more reactive silyl groups of the above formula, depending on the number of the terminals.

The reactive silyl group-containing polyether compound (B) may have the reactive silyl group in at least part of the molecular terminals and at least one, preferably 1.1 to five, more preferably 1.1 to three reactive silyl groups in part of the molecular terminals.

In the reactive silyl group represented by formula (1), R is a monovalent organic group having 1 to 20 carbon atoms and optionally having a substituent. R is preferably a straight- or branched-chain alkyl group of 1 to 8 carbon atoms, a fluoroalkyl group of 1 to 8 carbon atoms, or a phenyl group, more preferably a alkyl group of 1 to 6 carbon atoms, particularly preferably a methyl group. If two or more R groups are present in the same molecule, they may be the same or different. M is a hydroxyl group or a hydrolyzable group. The hydrolyzable group is directly bonded to the silicon atom and can form a siloxane bond by a hydrolysis reaction and/or a condensation reaction. Examples of the hydrolyzable group include a halogen atom, an alkoxy group, an acyloxy group, an alkenyloxy group, a carbamoyl group, an amino group, an aminooxy group, and a ketoxymate group. When the hydrolyzable group has a carbon atom or atoms, the number of the carbon atoms is preferably 6 or less, more preferably 4 or less. In particular, an alkoxy or alkenyloxy group of 4 or less carbon atoms is preferred, and a methoxy group or an ethoxy group is particularly preferred. When two or more M groups are present in the same molecule, they may be the same or different.

The reactive silyl group represented by formula (1) is preferably an alkoxysilyl group represented by formula (3):

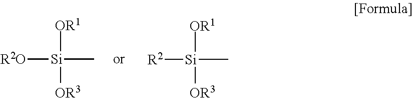

wherein R¹, R² and R³ each represent a monovalent hydrocarbon group of 1 to 6 carbon atoms and may be the same or different in the same molecule.

Examples of R¹, R² and R³ in the alkoxysilyl group represented by formula (3) include a straight- or branched-chain alkyl group of 1 to 6 carbon atoms, a straight- or branched-chain alkenyl group of 2 to 6 carbon atoms, a cycloalkyl group of 5 to 6 carbon atoms, and a phenyl group. Examples of —OR¹, —OR² and —OR³ in the formula include a methoxy group, an ethoxy group, a propoxy group, a propenyloxy group, and a phenoxy group. In particular, a methoxy group and an ethoxy group are preferred, and a methoxy group is particularly preferred.

The polyether skeleton of the polyether compound (B) preferably has a straight- or branched-chain oxyalkylene group of 1 to 10 carbon atoms as a repeating structural unit. The structural unit of the oxyalkylene group preferably has 2 to 6 carbon atoms, more preferably three carbon atoms. The repeating structural unit of the oxyalkylene group may be a single repeating structural unit or a block or random copolymer unit including two or more oxyalkylene groups. Examples of the oxyalkylene group include an oxyethylene group, an oxypropylene group, and an oxybutylene group. Among these oxyalkylene groups, an oxypropylene group (particularly —CH₂CH(CH₃)O—) is preferred as the structural unit, because of easiness of the production of the material, the stability of the material, and so on.

In a preferred mode, the main chain of the polyether compound (B) consists essentially of a polyether skeleton in addition to the reactive silyl group. In this context, “the main chain consists essentially of a polyoxyalkylene chain” means that the main chain may contain a small amount of any other chemical structure. For example, when the repeating structural unit of the oxyalkylene group is produced to form a polyether skeleton, it may also contain the chemical structure of an initiator and a linking group or the like to the reactive silyl group. The content of the repeating structural unit of the oxyalkylene group of the polyether skeleton is preferably 50% by weight or more, more preferably 80% by weight or more, based on the total weight of the polyether compound (B).

The polyether compound (B) may be a compound represented by formula (2): RₐM₃₋ₐSi—X—Y-(AO)ₙ—Z,

wherein R represents a monovalent organic group having 1 to 20 carbon atoms and optionally having a substituent, M represents a hydroxyl group or a hydrolyzable group; <a> represents an integer of 1 to 3, provided that in cases where two or more R groups, R groups is the same or different, and in cases where two or more M groups, M groups is the same or different, AO represents a straight- or branched-chain oxyalkylene group of 1 to 10 carbon atoms, n represents the average addition molar number of the oxyalkylene groups, which is from 1 to 1,700; X represents a straight- or branched-chain alkylene group of 1 to 20 carbon atoms, Y represents an ether bond, an ester bond, a urethane bond, or a carbonate bond and

Z represents a hydrogen atom, a monovalent hydrocarbon group of 1 to 10 carbon atoms,

a group represented by formula (2A): —Y¹—X—SiRₐM₃₋ₐ,

wherein R, M and X have the same meanings as defined above; and Y¹ represents a single bond, a —CO— bond, a —CONH— bond, or a —COO— bond, or

a group represented by formula (2B): -Q{-(OA)_{n-Y—X—SiR}ₐM₃₋ₐ}ₘ, wherein R, M, X, and Y have the same meanings as defined above, OA has the same meaning as AO defined above, n has the same meaning as defined above, Q represents a divalent or polyvalent hydrocarbon group of 1 to 10 carbon atoms, and m represents a number that is the same as the valence of the hydrocarbon group.

In formula (2), X is a straight- or branched-chain alkylene group of 1 to 20 carbon atoms, preferably 2 to 10 carbon atoms, more preferably three carbon atoms.

In formula (2), Y is a linking group that may be formed by a reaction with the terminal hydroxyl group of the oxyalkylene group of the polyether skeleton. Y is preferably an ether bond or a urethane bond, more preferably a urethane bond.

Z corresponds to a hydroxy compound having a hydroxyl group, which is involved as an initiator for the oxyalkylene polymer in the production of the compound represented by formula (2). When formula (2) has one reactive silyl group at one terminal, Z at the other terminal is a hydrogen atom or a monovalent hydrocarbon group of 1 to 10 carbon atoms. When Z is a hydrogen atom, the structural unit used is the same as that of the oxyalkylene polymer. When Z is a monovalent hydrocarbon group of 1 to 10 carbon atoms, the hydroxy compound used has one hydroxyl group.

When formula (2) has two or more reactive silyl groups at the terminals, Z corresponds to formula (2A) or (2B). When Z corresponds to formula (2A), the same structural unit as that of the oxyalkylene polymer is used for the hydroxy compound. When Z corresponds to formula (2B), the hydroxy compound used differs from the structural unit of the oxyalkylene polymer and has two hydroxyl groups. When Z corresponds to formula (2A), Y¹ is a linking group that may be formed by a reaction with the terminal hydroxyl group of the oxyalkylene group of the polyether skeleton as in the case of Y.

In view of reworkability, the polyether compound (B) represented by formula (2) is preferably a compound represented by formula (4): Z⁰-A²-O-(A¹O)ₙ—Z¹,

wherein A¹O represents an oxyalkylene group of 2 to 6 carbon atoms, n represents the average addition molar number of A¹O, which is from 1 to 1,700; Z¹ represents a hydrogen atom or -A²-Z⁰; and A² represents an alkylene group of 2 to 6 carbon atoms,

a compound represented by formula (5): Z⁰-A²-NHCOO-(A¹O)ₙ—Z², wherein A¹O represents an oxyalkylene group of 2 to 6 carbon atoms, n represents the average addition molar number of A¹O, which is from 1 to 1,700; Z² represents a hydrogen atom or —CONH-A²-Z⁰; and A² represents an alkylene group of 2 to 6 carbon atoms, or

a compound represented by formula (6): Z³—O-(A¹O)ₙ—C{—CH₂-(A¹O)ₙ—Z³}₂,

wherein A¹O represents an oxyalkylene group of 2 to 6 carbon atoms; n represents the average addition molar number of A¹O, which is from 1 to 1,700; Z³ represents a hydrogen atom or -A²-Z⁰ and at least one of the Z³ groups is -A²-Z⁰, and A² represents an alkylene group of 2 to 6 carbon atoms. In all of formulae (4), (5) and (6), Z⁰ represents the alkoxysilyl group represented by formula (3). The oxyalkylene group for A¹O may be any of a straight chain and a branched chain, and in particular, it is preferably an oxypropylene group. The alkylene group for A² may be any of a straight chain and a branched chain, and in particular, it is preferably a propylene group.

One of the compounds represented by formula (5), which is preferably used, may be a compound represented by formula (5A):

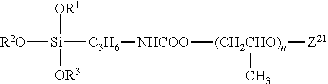

wherein R¹, R² and R³ each represent a monovalent hydrocarbon group of 1 to 6 carbon atoms and may be the same or different in the same molecule, n represents the average addition molar number of the oxypropylene groups, and Z²¹ represents a hydrogen atom or a trialkoxysilyl group represented by formula (5B):

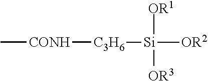

wherein R¹, R² and R³ have the same meanings as defined above.

In view of reworkability, the polyether compound (B) preferably has a number average molecular weight of 300 to 100,000. The lower limit of the number average molecular weight is preferably 500 or more, more preferably 1,000 or more, even more preferably 2,000 or more, still more preferably 3,000 or more, further more preferably 4,000 or more, further more preferably 5,000 or more, and the upper limit of the number average molecular weight is preferably 50,000 or less, more preferably 40,000 or less, even more preferably 30,000 or less, still more preferably 20,000 or less, further more preferably 10,000 or less. Preferred ranges of the number average molecular weight may be set using the upper and lower limits. In the polyether compound (B) represented by formula (2), (4), (5), or (6), n represents the average addition molar number of the oxyalkylene groups in the polyether skeleton. The polyether compound (B) is preferably controlled so as to have a number average molecular weight in the above range. When the polyether compound (B) has a number average molecular weight of 1,000 or more, n is generally from 10 to 1,700.

The Mw (the weight average molecular weight)/Mn (the number average molecular weight) ratio of the polymer is preferably 3.0 or less, more preferably 1.6 or less, particularly preferably 1.5 or less. In particular, an oxyalkylene polymer obtained by polymerizing a cyclic ether in the presence of an initiator and a catalyst of the composite metal cyanide complex shown below is preferably used to produce the reactive silyl group-containing polyether compound (B) with a low Mw/Mn ratio, and a method of modifying the terminal of such an oxyalkylene polymer material into a reactive silyl group is most preferred.

For example, the polyether compound (B) represented by formula (2), (4), (5), or (6) may be produced by a process including using an oxyalkylene polymer having a functional group at the molecular terminal as a raw material and linking a reactive silyl group to the molecular terminal through an organic group such as an alkylene group. The oxyalkylene polymer used as a raw material is preferably a hydroxyl-terminated polymer obtained by a ring-opening polymerization reaction of cyclic ether in the presence of a catalyst and an initiator.

The initiator to be used may be a compound having one or more active hydrogen atoms per molecule, such as a hydroxy compound having one or more hydroxyl groups in one molecule. For example, the initiator may be a hydroxyl group-containing compound such as ethylene glycol, propylene glycol, dipropylene glycol, butanediol, hexamethylene glycol, hydrogenated bisphenol A, neopentyl glycol, polybutadiene glycol, diethylene glycol, triethylene glycol, polyethylene glycol, allyl alcohol, methallyl alcohol, glycerin, trimethylolmethane, trimethylolpropane, pentaerythritol, or an alkylene oxide adduct of any of these compounds. The initiators may be used singly or in combination of two or more thereof.

A polymerization catalyst may be used in the ring-opening polymerization of cyclic ether in the presence of the initiator. Examples of the polymerization catalyst include alkali metal compounds such as potassium compounds such as potassium hydroxide and potassium methoxide and cesium compounds such as cesium hydroxide; composite metal cyanide complexes; metalloporphyrin complexes; and P═N bond-containing compounds.

In the polyether compound (B) represented by formula (2), (4), (5), or (6), the polyoxyalkylene chain preferably includes a polymerized unit of oxyalkylene formed by ring-opening polymerization of an alkylene oxide of 2 to 6 carbon atoms, preferably a repeating structural unit of an oxyalkylene group formed by ring-opening polymerization of at least one alkylene oxide selected from the group consisting of ethylene oxide, propylene oxide and butylene oxide, particularly preferably a repeating structural unit of oxyalkylene formed by ring-opening polymerization of propylene oxide. When the polyoxyalkylene chain includes two or more oxyalkylene group repeating structural units, the two or more oxyalkylene group repeating structural units may be arranged in a block or random manner.

For example, the polyether compound (B) represented by formula (5) may be obtained by a urethane forming reaction between a polymer having a polyoxyalkylene chain and a hydroxyl group and a compound having the reactive silyl group represented by formula (1) and an isocyanate group. An alternative method may also be used in which the reactive silyl group represented by formula (1) is introduced to the molecular terminal using an addition reaction of hydrosilane or mercaptosilane to the unsaturated group of an unsaturated group-containing oxyalkylene polymer such as an allyl-terminated polyoxypropylene monool obtained by polymerizing alkylene oxide with allyl alcohol as an initiator.

Examples of the method of introducing the reactive silyl group represented by formula (1) to the terminal group of a hydroxyl-terminated oxyalkylene polymer (also referred to as “oxyalkylene polymer material”) obtained by ring-opening polymerization of a cyclic ether in the presence of an initiator preferably include, but are not limited to, the methods (a), (b) and (c) described below in which the reactive silyl group is generally linked to the terminal group through an additional organic group.

(a) A method including introducing an unsaturated group to the terminal of an oxyalkylene polymer material having a hydroxyl group and then linking the reactive silyl group to the unsaturated group. Examples of this method may include the two methods (a-1) and (a-2) described below. (a-1) A method of allowing a hydrosilyl compound to react with the unsaturated group in the presence of a catalyst such as a platinum compound (a method using the so-called hydrosilylation reaction). (a-2) A method of allowing a mercaptosilane compound to react with the unsaturated group. Examples of the mercaptosilane compound include 3-mercaptopropyltrimethoxysilane, 3-mercaptopropyltriethoxysilane, 3-mercaptopropyltriisopropenyloxysilane, 3-mercaptopropylmethyldimethoxysilane, 3-mercaptopropyldimethylmonomethoxysilane, and 3-mercaptopropylmethyldiethoxysilane.

The reaction between the unsaturated group and the mercapto group may be performed using such a compound as a radical generator used as a radical polymerization initiator, or if desired, using radiation or heat with no radical polymerization initiator. Examples of the radical polymerization initiator include peroxide-type, azo-type and redox-type polymerization initiators, and metal compound catalysts, and specific examples thereof include 2,2′-azobisisobutyronitrile, 2,2′-azobis-2-methylbutyronitrile, benzoyl peroxide, tert-alkyl peroxyester, acetyl peroxide, and diisopropyl peroxycarbonate. The reaction between the unsaturated group and the mercapto group in the presence of a radical polymerization initiator is preferably performed for several hours to several tens of hours at a reaction temperature of generally 20 to 200° C., preferably 50 to 150° C., depending on the decomposition temperature (half-life temperature) of the polymerization initiator.

A method for introducing an unsaturated group to the terminal of the oxyalkylene polymer material may include allowing the oxyalkylene polymer material to react with a reactant having both an unsaturated group and a functional group capable of forming a bond, such as an ether bond, an ester bond, a urethane bond, or a carbonate bond, to the terminal hydroxyl group of the oxyalkylene polymer material. An alternative method may also be used in which an unsaturated group-containing epoxy compound such as allyl glycidyl ether is copolymerized in the process of polymerizing a cyclic ether in the presence of an initiator, so that the unsaturated group is introduced to at least part of the terminals of the oxyalkylene polymer material. The method is preferably performed at a temperature of 60 to 120° C. In general, the hydrosilylation reaction can sufficiently proceed in a reaction time of several hours or less.

(b) A method of allowing the oxyalkylene polymer material having a hydroxyl group at the terminal to react with an isocyanate silane compound having a reactive silyl group. Examples of such an isocyanate silane compound include 1-isocyanatomethyltrimethoxysilane, 1-isocyanatomethyltriethoxysilane, 1-isocyanatopropyltrimethoxysilane, 1-isocyanatopropyltriethoxysilane, 3-isocyanatopropyltrimethoxysilane, 3-isocyanatopropyltriethoxysilane, 1-isocyanatomethylmethyldimethoxysilane, 1-isocyanatomethyldimethylmonomethoxysilane, 1-isocyanatomethylmethyldiethoxysilane, 1-isocyanatopropylmethyldimethoxysilane, 1-isocyanatopropyldimethylmonomethoxysilane, 1-isocyanatopropylmethyldiethoxysilane, 3-isocyanatopropylmethyldimethoxysilane, 3-isocyanatopropyldimethylmonomethoxysilane, and 3-isocyanatopropylmethyldiethoxysilane. Among these compounds, 3-isocyanatopropyltrimethoxysilane and 1-isocyanatomethylmethyldimethoxysilane are more preferred, and 3-isocyanatopropyltrimethoxysilane is particularly preferred.

The reaction is preferably performed at a molar ratio (NCO/OH) of the isocyanate group (NCO) of the isocyanate silane compound to the hydroxyl group (OH) of the oxyalkylene polymer material of 0.80 to 1.05. This method has a small number of production steps and therefore makes it possible to significantly reduce the process time. This method produces no by-product impurities during the process and therefore does not need a complicated operation such as purification. The ratio (NCO/OH (molar ratio)) of the NCO group to the OH group is more preferably from 0.85 to 1.00. If the NCO ratio is too low, the remaining OH group may react with the reactive silyl group, so that the storage stability may be undesirable. In such a case, it is preferred that the isocyanate silane compound or a monoisocyanate compound should be newly allowed to react so that the excessive part of the OH groups can be consumed and that the silylation rate can be adjusted to the desired level.

A known urethane-forming reaction catalyst may also be used in the reaction between the hydroxyl group of the oxyalkylene polymer material and the isocyanate silane compound. While the reaction temperature and the reaction time required until the reaction is completed vary with the presence or absence and the amount of the urethane-forming reaction catalyst, the reaction is preferably performed at a temperature of generally 20 to 200° C., preferably 50 to 150° C. for several hours.

(c) A method including allowing the oxyalkylene polymer having a hydroxyl group at the molecular terminal to react with a polyisocyanate compound under isocyanate group-excess conditions to produce an oxyalkylene polymer having an isocyanate group in at least part of the terminals and further allowing the isocyanate group to react with a functional group-containing silicon compound. The functional group of the silicon compound is an active hydrogen-containing group selected from the group consisting of a hydroxyl group, a carboxyl group, a mercapto group, a primary amino group, and a secondary amino group. Examples of the silicon compound include aminosilane compounds such as N-phenyl-3-aminopropyltrimethoxysilane, 3-aminopropyltrimethoxysilane, 3-aminopropyltriethoxysilane, N-phenyl-3-aminopropylmethyldimethoxysilane, 3-aminopropylmethyldimethoxysilane, and 3-aminopropylmethyldiethoxysilane; and mercaptosilane compounds such as 3-mercaptopropyltrimethoxysilane and 3-mercaptopropylmethyldimethoxysilane. A known urethane-forming reaction catalyst may also be used in the reaction of the hydroxyl group of the oxyalkylene polymer material having and the polyisocyanate compound, and in the reaction of the isocyanate group and the functional group-containing silicon compound. While the reaction temperature and the reaction time required until the reaction is completed vary with the presence or absence and the amount of the urethane-forming reaction catalyst, the reaction is preferably performed at a temperature of generally 20 to 200° C., preferably 50 to 150° C. for several hours.

Specific examples of the polyether compound (B) include MS Polymers 5203, 5303 and 5810 manufactured by Kaneka Corporation; SILYL EST250 and EST280 manufactured by Kaneka Corporation; SAT10, SAT200, SAT220, SAT350, and SAT400 manufactured by Kaneka Corporation; and EXCESTAR S2410, S2420 or S3430 manufacture by ASAHI GLASS CO., LTD.

The content of the polyether compound (B) in the pressure-sensitive adhesive composition of the present invention is preferably from 0.001 to 20 parts by weight, based on 100 parts by weight of the (meth)acryl-based polymer (A). If the polyether compound (B) is less than 0.001 parts by weight, the effect of improving reworkability may be insufficient. The polyether compound (B) is preferably 0.01 parts by weight or more, more preferably 0.02 parts by weight or more, even more preferably 0.1 parts by weight or more, still more preferably 0.5 parts by weight or more. On the other hand, if the polyether compound (B) is more than 20 parts by weight, the humidity resistance may be insufficient, so that peeling may easily occur in a reliability test or the like. The polyether compound (B) is preferably 10 parts by weight or less, more preferably 5 parts by weight or less, even more preferably 3 parts by weight or less. The above upper limit or the lower limit may be used to define a preferred range of the content of the polyester compound (B). While preferred ranges of the polyether compound (B) content have been described above, it will be understood that the polyether compound (B) can be advantageously used in an amount of 1 part by weight or less or in an amount of 0.5 parts by weight or less.

The pressure-sensitive adhesive composition of the present invention also includes a crosslinking agent (C). An organic crosslinking agent or a polyfunctional metal chelate may also be used as the crosslinking agent (C). Examples of the organic crosslinking agent include an isocyanate crosslinking agent, an epoxy crosslinking agents, a peroxide crosslinking agents and an imine crosslinking agents. The polyfunctional metal chelate may include a polyvalent metal and an organic compound that is covalently or coordinately bonded to the metal. Examples of the polyvalent metal atom include Al, Cr, Zr, Co, Cu, Fe, Ni, V, Zn, In, Ca, Mg, Mn, Y, Ce, Sr, Ba, Mo, La, Sn, and Ti. The organic compound has a covalent or coordinate bond-forming atom such as an oxygen atom. Examples of the organic compound include alkyl esters, alcohol compounds, carboxylic acid compounds, ether compounds, and ketone compounds.

The crosslinking agent (C) to be used is preferably selected from an isocyanate crosslinking agent and/or a peroxide crosslinking agent. Examples of such a compound for the isocyanate crosslinking agent include isocyanate monomers such as tolylene diisocyanate, chlorophenylene diisocyanate, tetramethylene diisocyanate, xylylene diisocyanate, diphenylmethane diisocyanate, and hydrogenated diphenylmethane diisocyanate, and isocyanate compounds produced by adding any of these isocyanate monomers to trimethylolpropane or the like; and urethane prepolymer type isocyanates produced by the addition reaction of isocyanurate compounds, burette type compounds, or polyether polyols, polyester polyols, acrylic polyols, polybutadiene polyols, polyisoprene polyols, or the like. Particularly preferred is a polyisocyanate compound such as one selected from the group consisting of hexamethylene diisocyanate, hydrogenated xylylene diisocyanate, and isophorone diisocyanate, or a derivative thereof. Examples of one selected from the group consisting of hexamethylene diisocyanate, hydrogenated xylylene diisocyanate, and isophorone diisocyanate, or a derivative thereof include hexamethylene diisocyanate, hydrogenated xylylene diisocyanate, isophorone diisocyanate, polyol-modified hexamethylene diisocyanate, polyol-modified hydrogenated xylylene diisocyanate, trimer-type hydrogenated xylylene diisocyanate, and polyol-modified isophorone diisocyanate. The listed polyisocyanate compounds are preferred, because their reaction with a hydroxyl group quickly proceeds as if an acid or a base contained in the polymer acts as a catalyst, which particularly contributes to the rapidness of the crosslinking.

Any peroxide capable of generating active radical species by heating or photoirradiation and promoting the crosslinking of the base polymer in the pressure-sensitive adhesive composition may be appropriately used. In view of workability and stability, a peroxide with a one-minute half-life temperature of 80° C. to 160° C. is preferably used, and a peroxide with a one-minute half-life temperature of 90° C. to 140° C. is more preferably used.

Examples of the peroxide for use in the present invention include di(2-ethylhexyl) peroxydicarbonate (one-minute half-life temperature: 90.6° C.), di(4-tert-butylcyclohexyl) peroxydicarbonate (one-minute half-life temperature: 92.1° C.), di-sec-butyl peroxydicarbonate (one-minute half-life temperature: 92.4° C.), tert-butyl peroxyneodecanoate (one-minute half-life temperature: 103.5° C.), tert-hexyl peroxypivalate (one-minute half-life temperature: 109.1° C.), tert-butyl peroxypivalate (one-minute half-life temperature: 110.3° C.), dilauroyl peroxide (one-minute half-life temperature: 116.4° C.), di-n-octanoylperoxide (one-minute half-life temperature: 117.4° C.), 1,1,3,3-tetramethylbutylperoxy-2-ethyl hexanoate (one-minute half-life temperature: 124.3° C.), di(4-methylbenzoyl) peroxide (one-minute half-life temperature: 128.2° C.), dibenzoyl peroxide (one-minute half-life temperature: 130.0° C.), tert-butyl peroxyisobutylate (one-minute half-life temperature: 136.1° C.), and 1,1-di(tert-hexylperoxy)cyclohexane (one-minute half-life temperature: 149.2° C.). In particular, di(4-tert-butylcyclohexyl) peroxydicarbonate (one-minute half-life temperature: 92.1° C.), dilauroyl peroxide (one-minute half-life temperature: 116.4° C.), dibenzoyl peroxide (one-minute half-life temperature: 130.0° C.), or the like is preferably used, because they can provide high crosslinking reaction efficiency.

The half life of the peroxide is an indicator of how fast the peroxide can be decomposed and refers to the time required for the amount of the peroxide to reach one half of its original value. The decomposition temperature required for a certain half life and the half life time obtained at a certain temperature are shown in catalogs furnished by manufacturers, such as “Organic Peroxide Catalog, 9th Edition, May, 2003” furnished by NOF CORPORATION.

The amount of the crosslinking agent (C) to be used is preferably from 0.01 to 20 parts by weight, more preferably from 0.03 to 10 parts by weight, based on 100 parts by weight of the (meth)acrylic polymer (A). If the amount of the crosslinking agent (C) is less than 0.01 parts by weight, the cohesive strength of the pressure-sensitive adhesive may tend to be insufficient, and foaming may occur during heating. If the amount of the crosslinking agent (C) is more than 20 parts by weight, the humidity resistance may be insufficient, so that peeling may easily occur in a reliability test or the like.

One of the isocyanate crosslinking agents may be used alone, or a mixture of two or more of the isocyanate crosslinking agents may be used. The total content of the polyisocyanate compound crosslinking agent(s) is preferably from 0.01 to 2 parts by weight, more preferably from 0.02 to 2 parts by weight, even more preferably from 0.05 to 1.5 parts by weight, based on 100 parts by weight of the (meth)acrylic polymer (A). The content may be appropriately controlled taking into account the cohesive strength or the prevention of peeling in a durability test or the like.

One of the peroxide crosslinking agents may be used alone, or a mixture of two or more of the peroxide crosslinking agent may be used. The total content of the peroxide(s) is preferably from 0.01 to 2 parts by weight, more preferably from 0.04 to 1.5 parts by weight, even more preferably from 0.05 to 1 part by weight, based on 100 parts by weight of the (meth)acrylic polymer (A). The content of the peroxide(s) may be appropriately selected in this range in order to control the workability, reworkability, crosslink stability or peeling properties.

The amount of decomposition of the peroxide may be determined by measuring the peroxide residue after the reaction process by high performance liquid chromatography (HPLC).

More specifically, for example, after the reaction process, about 0.2 g of each pressure-sensitive adhesive composition is taken out, immersed in 10 ml of ethyl acetate, subjected to shaking extraction at 25° C. and 120 rpm for 3 hours in a shaker, and then allowed to stand at room temperature for 3 days. Thereafter, 10 ml of acetonitrile is added, and the mixture is shaken at 25° C. and 120 rpm for 30 minutes. About 10 μl of the liquid extract obtained by filtration through a membrane filter (0.45 μm) is subjected to HPLC by injection and analyzed so that the amount of the peroxide after the reaction process is determined.

The pressure-sensitive adhesive composition of the present invention may further contain a silane coupling agent (D). The durability or the reworkability can be improved using the silane coupling agent (D). Examples of silane coupling agent include epoxy group-containing silane coupling agents such as 3-glycidoxypropyltrimethoxysilane, 3-glycidoxypropyltriethoxysilane, 3-glycidoxypropylmethyldiethoxysilane, and 2-(3,4-epoxycyclohexyl)ethyltrimethoxysilane; amino group-containing silane coupling agents such as 3-aminopropyltrimethoxysilane, N-(2-aminoethyl)-3-aminopropylmethyldimethoxysilane, and 3-triethoxysilyl-N-(1,3-dimethylbutylidene)propylamine; (meth)acrylic group-containing silane coupling agents such as 3-acryloxypropyltrimethoxysilane and 3-methacryloxypropyltriethoxysilane; and isocyanate group-containing silane coupling agents such as 3-isocyanatepropyltriethoxysilane.

One of the silane coupling agents (D) may be used alone, or a mixture of two or more of the silane coupling agents. The total content of the silane coupling agent(s) is preferably from 0.001 to 5 parts by weight, more preferably from 0.01 to 1 part by weight, even more preferably from 0.02 to 1 part by weight, still more preferably from 0.05 to 0.6 parts by weight, based on 100 parts by weight of the (meth)acrylic polymer (A). The content of the silane coupling agent may be appropriately amount in order to control improve durability and maintain adhesive strength to the optical member such as a liquid crystal cell.

The pressure-sensitive adhesive composition of the present invention may also contain any other known additive. For example, a tackifier, a powder such as a colorant and a pigment, a dye, a surfactant, a plasticizer, a surface lubricant, a leveling agent, a softening agent, an antioxidant, an age resister, a light stabilizer, an ultraviolet absorbing agent, a polymerization inhibitor, an inorganic or organic filler, a metal powder, or a particle- or foil-shaped material may be added as appropriate depending on the intended use. A redox system including an added reducing agent may also be used in the controllable range.

The pressure-sensitive adhesive composition is used to form a pressure-sensitive adhesive layer. To form the pressure-sensitive adhesive layer, it is preferred that the total amount of the addition of the crosslinking agent should be controlled and that the effect of the crosslinking temperature and the crosslinking time should be carefully taken into account.

The crosslinking temperature and the crosslinking time may be controlled depending on the crosslinking agent used. The crosslinking temperature is preferably 170° C. or less.

The crosslinking process may be performed at the temperature of the process of drying the pressure-sensitive adhesive layer, or the crosslinking process may be separately performed after the drying process.

The crosslinking time is generally from about 0.2 to about 20 minutes, preferably from about 0.5 to about 10 minutes, while it may be set taking into account productivity and workability.

In an embodiment of the present invention, the pressure-sensitive adhesive optical member such as the pressure-sensitive adhesive optical film includes an optical film and a pressure-sensitive adhesive layer that is formed on at least one side of the optical film and produced with the pressure-sensitive adhesive.

For example, the pressure-sensitive adhesive layer may be formed by a method including applying the pressure-sensitive adhesive composition to a release-treated separator or the like, removing the polymerization solvent and so on by drying to form a pressure-sensitive adhesive layer and then transferring it to an optical film, or by a method including applying the pressure-sensitive adhesive composition to an optical film and removing the polymerization solvent and so on by drying to form a pressure-sensitive adhesive layer on the optical film. Before the pressure-sensitive adhesive is applied, in addition at least one solvent other than the polymerization solvent may be added to the pressure-sensitive adhesive.

A silicone release liner is preferably used as the release-treated separator. The pressure-sensitive adhesive composition of the present invention may be applied to such a liner and dried to form a pressure-sensitive adhesive layer. In this process, the pressure-sensitive adhesive may be dried using any appropriate method depending on the purpose. A method of drying by heating the coating film is preferably used. The heat drying temperature is preferably from 40° C. to 200° C., more preferably from 50° C. to 180° C., particularly preferably from 70° C. to 170° C. When the heating temperature is set in the above range, a pressure-sensitive adhesive having good adhesive properties can be obtained.

Any appropriate drying time may be used. The drying time is preferably from 5 seconds to 20 minutes, more preferably from 5 seconds to 10 minutes, particularly preferably from 10 seconds to 5 minutes.

An anchor layer may also be formed on the surface of the optical film or the surface of the optical film may be subjected to any of various adhesion-facilitating treatments such as a corona treatment and a plasma treatment, and then forming the pressure-sensitive adhesive layer. The surface of the pressure-sensitive adhesive layer may also be subjected to an adhesion-facilitating treatment.

Various methods may be used to form the pressure-sensitive adhesive layer. Specific examples of such methods include roll coating, kiss roll coating, gravure coating, reverse coating, roll brush coating, spray coating, dip roll coating, bar coating, knife coating, air knife coating, curtain coating, lip coating, and extrusion coating with a die coater or the like.

The thickness of the pressure-sensitive adhesive layer is typically, but not limited to, from about 1 to 100 μm, preferably from 2 to 50 μm, more preferably from 2 to 40 μm, further preferably from 5 to 35 μm.

When the pressure-sensitive adhesive layer is exposed, the pressure-sensitive adhesive layer may be protected with a sheet having undergone release treatment (a separator) before practical use.

Examples of the material for forming the separator include a plastic film such as a polyethylene, polypropylene, polyethylene terephthalate, or polyester film, a porous material such as paper, cloth and nonwoven fabric, and an appropriate thin material such as a net, a foamed sheet, a metal foil, and a laminate thereof. In particular, a plastic film is preferably used, because of its good surface smoothness.

The plastic film may be any film capable of protecting the pressure-sensitive adhesive layer, and examples thereof include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the separator is generally from about 5 to about 200 μm, preferably from about 5 to about 100 μm. If necessary, the separator may be treated with a release agent such as a silicone, fluorine, long-chain alkyl, or fatty acid amide release agent, or may be subjected to release and antifouling treatment with silica powder or to antistatic treatment of coating type, kneading and mixing type, vapor-deposition type, or the like. In particular, if the surface of the separator is appropriately subjected to release treatment such as silicone treatment, long-chain alkyl treatment, and fluorine treatment, the releasability from the pressure-sensitive adhesive layer can be further increased.

In the above production method, the release-treated sheet may be used without modification as a separator for the pressure-sensitive adhesive sheet, the pressure-sensitive adhesive optical film or the like, so that the process can be simplified.

The optical film may be of any type for use in forming image displays such as liquid crystal displays. For example, a polarizing plate is exemplified as the optical film. A polarizing plate including a polarizer and a transparent protective film provided on one or both sides of the polarizer is generally used. Concerning optical films, for example, triacetylcellulose resins, (meth)acrylic resins, norbornene resins, or the like are used to form transparent protective films. Particularly when the (meth)acryl-based polymer (A) is the (meth)acryl-based polymer (A′), the pressure-sensitive adhesive optical film of the present invention has good durability for these various type materials.

A polarizer is not limited especially but various kinds of polarizer may be used. As a polarizer, for example, a film that is uniaxially stretched after having dichromatic substances, such as iodine and dichromatic dye, absorbed to hydrophilic high molecular weight polymer films, such as polyvinyl alcohol type film, partially formalized polyvinyl alcohol type film, and ethylene-vinyl acetate copolymer type partially saponified film; poly-ene type alignment films, such as dehydrated polyvinyl alcohol and dehydrochlorinated polyvinyl chloride, etc. may be mentioned. In these, a polyvinyl alcohol type film on which dichromatic materials such as iodine, is absorbed and aligned after stretched is suitably used. Although thickness of polarizer is not especially limited, the thickness of about 5 to 80 μm is commonly adopted.

A polarizer that is uniaxially stretched after a polyvinyl alcohol type film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol type film may be dipped in water and rinsed if needed. By rinsing polyvinyl alcohol type film with water, effect of preventing un-uniformity, such as unevenness of dyeing, is expected by making polyvinyl alcohol type film swelled in addition that also soils and blocking inhibitors on the polyvinyl alcohol type film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

A thermoplastic resin with a high level of transparency, mechanical strength, thermal stability, moisture blocking properties, isotropy, and the like may be used as a material for forming the transparent protective film. Examples of such a thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic olefin polymer resins (norbornene resins), polyarylate resins, polystyrene resins, polyvinyl alcohol resins, and any mixture thereof. The transparent protective film is generally laminated to one side of the polarizer with the adhesive layer, but thermosetting resins or ultraviolet curing resins such as (meth)acrylic, urethane, acrylic urethane, epoxy, or silicone resins may be used to other side of the polarizer for the transparent protective film. The transparent protective film may also contain at least one type of any appropriate additive. Examples of the additive include an ultraviolet absorbing agent, an antioxidant, a lubricant, a plasticizer, a release agent, an anti-discoloration agent, a flame retardant, a nucleating agent, an antistatic agent, a pigment, and a colorant. The content of the thermoplastic resin in the transparent protective film is preferably from 50 to 100% by weight, more preferably from 50 to 99% by weight, still more preferably from 60 to 98% by weight, particularly preferably from 70 to 97% by weight. If the content of the thermoplastic resin in the transparent protective film is 50% by weight or less, high transparency and other properties inherent in the thermoplastic resin can fail to be sufficiently exhibited.

Further an optical film of the present invention may be used as other optical layers, such as a reflective plate, a transflective plate, a retardation plate (a half wavelength plate and a quarter wavelength plate included), and a viewing angle compensation film, which may be used for formation of a liquid crystal display etc. These are used in practice as an optical film, or as one layer or two layers or more of optical layers laminated with polarizing plate.

Although an optical film with the above described optical layer laminated to the polarizing plate may be formed by a method in which laminating is separately carried out sequentially in manufacturing process of a liquid crystal display etc., an optical film in a form of being laminated beforehand has an outstanding advantage that it has excellent stability in quality and assembly workability, etc., and thus manufacturing processes ability of a liquid crystal display etc. may be raised. Proper adhesion means, such as a pressure-sensitive adhesive layer, may be used for laminating. On the occasion of adhesion of the above described polarizing plate and other optical layers, the optical axis may be set as a suitable configuration angle according to the target retardation characteristics etc.

The pressure-sensitive adhesive optical film of the present invention is preferably used to form various types of image displays such as liquid crystal displays. Liquid crystal displays may be formed according to conventional techniques. Specifically, liquid crystal displays are generally formed by appropriately assembling a liquid crystal cell and the pressure-sensitive adhesive optical film and optionally other component such as a lighting system and incorporating a driving circuit according to any conventional technique, except that the pressure-sensitive adhesive optical film of the present invention is used. Any type of liquid crystal cell may also be used such as a TN type, an STN type, a n type a VA type and IPS type.

Suitable liquid crystal displays, such as liquid crystal display with which the pressure-sensitive adhesive optical film has been located at one side or both sides of the liquid crystal cell, and with which a backlight or a reflective plate is used for a lighting system may be manufactured. In this case, the optical film may be installed in one side or both sides of the liquid crystal cell. When installing the optical films in both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

### EXAMPLES

The present invention is more specifically described by the examples below, which are not intended to limit the scope of the present invention. In each example, parts and % are all by weight. Unless otherwise stated below, the conditions of room temperature standing are 23° C. and 65% RH in all the cases. When the (meth)acryl-based polymer (A) is the (meth)acryl-based polymer (A′), the different terms “Production Example′,” “Example′” and “Comparative Example′” are used.

### <Measurement of Weight Average Molecular Weight of (Meth)acrylic Polymer (A)>

The weight average molecular weight (Mw) of the (meth)acrylic polymer (A) was measured by GPC (Gel Permeation Chromatography).

Analyzer: HLC-8120GPC manufactured by TOSOH CORPORATION
Columns: G7000H_{XL}+GMH_{XL}+GMH_{XL} manufactured by TOSOH CORPORATION
Column size: each 7.8 mm φ×30 cm, 90 cm in total
Column temperature: 40° C.
Flow rate: 0.8 ml/minute
Injection volume: 100 μl
Eluent: tetrahydrofuran
Detector: differential refractometer (RI)
Standard sample: polystyrene

### <Measurement of Number Average Molecular Weight of Polyether Compound (B)>

The number average molecular weight of the polyether compound (B) was measured by GPC (Gel Permeation Chromatography).

Analyzer: HLC-8120GPC manufactured by TOSOH CORPORATION
Column: TSK gel, Super HZM-H/HZ4000/HZ2000
Column size: 6.0 mm I.D.×150 mm
Column temperature: 40° C.
Flow rate: 0.6 ml/minute
Injection volume: 20 μl
Eluent: tetrahydrofuran
Detector: differential refractometer (RI)
Standard sample: polystyrene

### (Preparation of Polarizing Plate)

An 80 μm-thick polyvinyl alcohol film was stretched to 3 times between rolls different in velocity ratio, while it was dyed in a 0.3% iodine solution at 30° C. for 1 minute. The film was then stretched to a total draw ratio of 6 times, while it was immersed in an aqueous solution containing 4% of boric acid and 10% of potassium iodide at 60° C. for 0.5 minutes. The film was then washed by immersion in an aqueous solution containing 1.5% of potassium iodide at 30° C. for 10 seconds and then dried at 50° C. for 4 minutes to give a polarizer. Saponified triacetylcellulose films each with a thickness of 80 μm were bonded to both sides of the polarizer with a polyvinyl alcohol adhesive to form a polarizing plate.

In Examples′ and Comparative Examples′, polarizing plates were also prepared as described above, except that 30 μm-thick acrylic films (lactone-modified acrylic resin films) or 60 μm-thick norbornene based films (ZEONOR Film ZB12, manufactured by ZEON CORPORATION) were used in place of the 80 μm-thick triacetylcellulose films. The resulting three polarizing plates having different transparent protective films were used in the Examples′ and Comparative Examples′.

### Production Example 1

### Preparation of Acrylic Polymer (A1)

To a four-neck flask equipped with a stirring blade, a thermometer, a nitrogen gas introducing tube, and a condenser were added 100 parts of butyl acrylate, 5 parts of acrylic acid, 1 part of 2-hydroxyethyl acrylate, 0.1 parts of 2,2′-azobisisobutyronitrile as a polymerization initiator, and 100 g of ethyl acetate. Nitrogen gas was introduced to replace the air, while the mixture was gently stirred, and then a polymerization reaction was performed for 8 hours, while the temperature of the liquid in the flask was kept at about 55° C., so that a solution of an acrylic polymer (A1) with a weight average molecular weight (Mw) of 2,200,000 was prepared.

### Production Example 2

### Preparation of Acrylic Polymer (A2)

To a four-neck flask equipped with a stirring blade, a thermometer, a nitrogen gas introducing tube, and a condenser were added 99 parts of butyl acrylate, 1 part of 4-hydroxybuthyl acrylate, 0.1 parts of 2,2′-azobisisobutyronitrile as a polymerization initiator, and 100 g of ethyl acetate. Nitrogen gas was introduced to replace the air, while the mixture was gently stirred, and then a polymerization reaction was performed for 8 hours, while the temperature of the liquid in the flask was kept at about 55° C., so that a solution of an acrylic polymer (A2) with a weight average molecular weight (Mw) of 1,600,000 was prepared.

### Production Example 3

### Preparation of Polyether Compound (B1)

A polymer (3,000 g), that is polyoxypropylenediol (16,000 in number average molecular weight, 7.7 in hydroxyl value) obtained by ring-opening polymerization of propylene oxide with polyoxypropylenediol (1,000 in number average molecular weight) in the presence of a zinc hexacyanocobaltate-glyme complex catalyst, was placed in a pressure-resistant reaction vessel (5 L in internal volume) and dehydrated under reduced pressure while the internal temperature was kept at 110° C. Subsequently, the atmosphere in the reaction vessel was replaced with nitrogen gas, and 86.1 g of 3-isocyanate propyltrimethoxysilane (95% in purity) was added so that NCO/OH could be 0.97 while the internal temperature was kept at 50° C. Subsequently, the internal temperature was kept at 80° C. for 8 hours, so that the polymer 1 and 3-isocyanate propyltrimethoxysilane were subjected to a urethane-forming reaction. The resulting polyether compound (B1) having trimethoxysilyl groups at both terminals was used. The polyether compound (B1) had a viscosity of 20.0 Pa·s (25° C.), a number average molecular weight of 15,000, and Mw/Mn of 1.38. The resulting polyether compound (B1) is represented by the formula (5A) in which R¹, R² and R³ are all methyl groups, and Z²¹ is a group represented by the formula (5B).

### Example 1

### (Preparation of Pressure-Sensitive Adhesive Composition)

Based on 100 parts of the solids of the acryl-based polymer (A1) solution obtained in Production Example 1, 0.02 parts of the polyether compound (B1) prepared in Production Example 3 and 0.30 parts of an isocyanate crosslinking agent (tolylene diisocyanate adduct of trimethylolpropane, Coronate L manufactured by Nippon Polyurethane Industry Co., Ltd.) were added to the acryl-based polymer (A1) solution, so that a solution (11% in solids content) of an acryl-based pressure-sensitive adhesive composition was prepared.

### (Preparation of Pressure-Sensitive Adhesive Layer-Carrying Polarizing Plate)

The acrylic pressure-sensitive adhesive solution was then applied to one side of a silicone-treated, 38 μm-thick, polyethylene terephthalate (PET) film (MRF38 manufactured by Mitsubishi Polyester Film Corporation) so that a 23 μm-thick pressure-sensitive adhesive layer could be formed after drying. The acrylic pressure-sensitive adhesive solution was then dried at 155° C. for 1 minute, and the pressure-sensitive adhesive layer was then transferred to a polarizing plate (SEG manufactured by NITTO DENKO CORPORATION) to obtain a pressure-sensitive adhesive layer-carrying polarizing plate.

### Examples 2 to 6

Pressure-sensitive adhesive layer-carrying polarizing plates were prepared as in Example 1, except that the amount of the polyether compound (B1) used was changed as shown in Table 1 and that the silane coupling agent was used in the ratio shown in Table 1.

### Examples 7 and 8

Pressure-sensitive adhesive layer-carrying polarizing plates were prepared as in Example 1, except that Excestar 2420 or 3430 manufactured by ASAHI GLASS CO., LTD. was used in place of the polyether compound (B1) as shown in Table 1.

### Example 9

### (Preparation of Pressure-Sensitive Adhesive Composition)

Based on 100 parts of the solids of the acryl-based polymer (A2) solution obtained in Production Example 2, 0.02 parts of the polyether compound (B1) prepared in Production Example 3, 0.02 parts of an isocyanate crosslinking agent (trimethylolpropane xylylene diisocyanate, Takenate D110N manufactured by Mitsui Takeda Chemicals, Inc.), and 0.3 parts of benzoyl peroxide (Nyper BMT, manufactured by NOF Corporation) were added to the acryl-based polymer (A2) solution, so that a solution (15% in solids content) of an acryl-based pressure-sensitive adhesive composition was prepared.

### (Preparation of Pressure-Sensitive Adhesive Layer-Carrying Polarizing Plate)

The acrylic pressure-sensitive adhesive solution was then applied to one side of a silicone-treated, 38 μm-thick, polyethylene terephthalate (PET) film (MRF38 manufactured by Mitsubishi Polyester Film Corporation) so that a 23 μm-thick pressure-sensitive adhesive layer could be formed after drying. The acrylic pressure-sensitive adhesive solution was then dried at 155° C. for 1 minute, and the pressure-sensitive adhesive layer was then transferred to a polarizing plate (SEG manufactured by NITTO DENKO CORPORATION) to obtain a pressure-sensitive adhesive layer-carrying polarizing plate.

### Comparative Example 1

A pressure-sensitive adhesive layer-carrying polarizing plate was prepared as in Example 1, except that the polyether compound (B1) was not used or the type of the acryl-based polymer or the type or amount of the crosslinking agent used were changed as shown in Table 1.

### Examples 10 to 25 and Comparative Examples 2 to 4

Pressure-sensitive adhesive layer-carrying polarizing plates were prepared as in Example 1, except that the type or amount of the polyether compound (B) used was changed and that the crosslinking agent and the silane coupling agent were each used in the ratio shown in Table 2.

### Examples 26 to 33 and Comparative Examples 5 to 7

Pressure-sensitive adhesive layer-carrying polarizing plates were prepared as in Example 9, except that the type or amount of the polyether compound (B) used was changed and that the crosslinking agent and the silane coupling agent were each used in the ratio shown in Table 3.

The pressure-sensitive adhesive layer-carrying polarizing plate (sample) obtained in each of Examples 1 to 9 and Comparative Example 1 described above was evaluated as described below. The results of the evaluation are shown in Table 1.

### <Reworkability>

The sample was cut into a piece of 25 mm (width)×100 mm (length), which was bonded to a 0.5 mm-thick non-alkali glass plate (1737 manufactured by Corning Incorporated) using a laminator. The sample was then autoclaved at 50° C. under 5 atm for 15 minutes, so that it was completely bonded to the glass plate (initial stage). Thereafter, the sample was heat-treated at 60° C. under dry conditions for 120 hours (after heating), and then, the adhesive strength of the sample piece was measured.

The sample was peeled from the glass plate at a peel angle of 90° and a peel rate of 300 mm/minute with a tensile tester (Autograph SHIMAZU AG-1 10KN), when the adhesive strength (N/25 mm, 80 m in length during the measurement) was measured. In the measurement, sampling was performed at an interval of 0.5 seconds for one measurement, and the average was used as the measured value.

### <Durability>

The sample was formed with a size of 37 inches and bonded to a 0.7 mm-thick non-alkali glass plate (1737 manufactured by Corning Incorporated) using a laminator. The sample was then autoclaved at 50° C. under 0.5 MPa for 15 minutes, so that it was completely bonded to the non-alkali glass plate. The autoclaved sample was humidity-treated under an atmosphere at 60° C. and 90% RH for 500 hours (humidifying test); or subjected to 300 cycles of one hour in 85° C. and -40° C. environments (heat shock test). Thereafter, the appearance between the polarizing plate and the glass plate was visually evaluated according to the criteria below.

⊙: There is no change in the appearance, such as foaming, peeling or separation.
◯: Peeling or foaming is slightly observed at an end portion, but there is no practical problem.
Δ: Peeling or foaming is observed at an end portion, but there is no practical problem if the intended use is not special.
x: Remarkable peeling is observed at an end portion to cause a practical problem.

TABLE 1

| | Pressure-sensitive adhesive composition | | | | | | | | | | | | | |
|---|---|---|---|---|---|---|---|---|---|---|---|---|---|---|
| | | | | | | | | | Silane | | Evaluation | | | |
| | | Polyether compound (B) | | | Crosslinking agent (C) | | | | coupling agent | | Reworkability | | | |
| | | | Number | | Isocyanate | | Peroxide | | (D) | | Initial | After | Durability | |
| | Type of | | average | Added | | Added | | Added | | Added | stage | heating | | Heat |
| | acryl-based | | molecular | amount | | amount | | amount | | amount | (N/25 | (N/25 | Humidifying | shock |
| | polymer (A) | Type | weight | (parts) | Type | (parts) | Type | (parts) | Type | (parts) | mm) | mm) | test | test |
| Example 1 | Polymer A1 | *1 | 15000 | 0.005 | C/L | 0.6 | — | — | — | — | 5.2 | 9.1 | ◯ | [symbol] |
| Example 2 | Polymer A1 | *1 | 15000 | 0.02 | C/L | 0.6 | — | — | — | — | 3.5 | 6.8 | ◯ | [symbol] |
| Example 3 | Polymer A1 | *1 | 15000 | 0.05 | C/L | 0.6 | — | — | — | — | 3.1 | 4.2 | ◯ | [symbol] |
| Example 4 | Polymer A1 | *1 | 15000 | 0.5 | C/L | 0.6 | — | — | — | — | 2.5 | 3.1 | ◯ | ◯ |
| Example 5 | Polymer A1 | *1 | 15000 | 5 | C/L | 0.6 | — | — | — | — | 0.4 | 1.2 | Δ | Δ |
| Example 6 | Polymer A1 | *1 | 15000 | 0.02 | C/L | 0.6 | — | — | KBM- | 0.1 | 3.9 | 7.3 | [symbol] | [symbol] |
| | | | | | | | | | 403 | | | | | |
| Example 7 | Polymer A1 | *2 | 19900 | 0.05 | C/L | 0.6 | — | — | — | — | 4.5 | 8.3 | ◯ | [symbol] |
| Example 8 | Polymer A1 | *3 | 18100 | 0.05 | C/L | 0.6 | — | — | — | — | 5.8 | 10.3 | ◯ | [symbol] |
| Example 9 | Polymer A2 | *1 | 15000 | 0.02 | D110N | 0.02 | BPO | 0.3 | — | — | 3.3 | 6.0 | ◯ | [symbol] |
| Comparative | Polymer A1 | — | — | — | C/L | 0.6 | — | — | — | — | 8.4 | 16.6 | ◯ | ◯ |
| Example 1 | | | | | | | | | | | | | | |

The pressure-sensitive adhesive layer-carrying polarizing plate (sample) obtained in each of Examples 10 to 33 and Comparative Examples 2 to 7 described above was evaluated as described below. The results of the evaluation are shown in Tables 2 and 3.

### <Reworkability>

The sample was cut into a piece of 420 mm long by 320 mm wide. The sample piece was bonded to a 0.7 mm thick non-alkali glass plate (1737 manufactured by Corning Incorporated) using a laminator and then autoclaved under 5 atm at 50° C. for 15 minutes, so that it was completely bonded to the glass plate (initial stage). Subsequently, the sample piece was heat-treated under dry conditions at 60° C. for 48 hours (after heating). The adhesive strength of the sample piece was measured by the same method as described above.

The same sample piece as used in the measurement of the adhesive strength was peeled off from the non-alkali glass plate by hand, when the reworkability was evaluated according to the criteria below. Three sample pieces were prepared by the procedure described above, and the evaluation of the reworkability was repeated three times using them.

⊙: All of the three pieces were successfully peeled off without adhesive residue or breakage of the film.
◯: In some of the three pieces, the film was broken but peeled off by re-peeling.
Δ: In all of the three pieces, the film was broken but peeled off by re-peeling.
x: In all of the three pieces, an adhesive residue occurred, or the film was broken and failed to be peeled off even by repeated peeling.

### <Durability>

The sample was formed with a size of 37 inches and bonded to a 0.7 mm-thick non-alkali glass plate (1737 manufactured by Corning Incorporated) using a laminator. The sample was then autoclaved at 50° C. under 0.5 MPa for 15 minutes, so that it was completely bonded to the non-alkali glass plate. The autoclaved sample was heat-treated under an atmosphere at 80° C., 100° C. or 110° C. for 500 hours (heating test); or was humidity-treated under an atmosphere at 60° C. and 90% RH, or 65° C. and 95% RH for 500 hours (humidifying test); or subjected to 300 cycles of one hour in 85° C. and −40° C. environments (heat shock test). Thereafter, the appearance between the polarizing plate and the glass plate was visually evaluated according to the criteria below.

⊙: There is no change in the appearance, such as foaming, peeling or separation.
◯: Peeling or foaming is slightly observed at an end portion, but there is no practical problem.
Δ: Peeling or foaming is observed at an end portion, but there is no practical problem if the intended use is not special.
x: Remarkable peeling is observed at an end portion to cause a practical problem.

TABLE 2

| | Pressure-sensitive adhesive composition | | | | | | | | | |
|---|---|---|---|---|---|---|---|---|---|---|
| | | Polyether compound | | | | | | | Silane | |
| | | (B) | | | | | | | coupling | |
| | | | Number | | Crosslinking agent (C) | | | | agent (D) | |
| | Type | | average | Added | Isocyanate | | Peroxide | | | Added |
| | of acryl-based | | molecular | amount | | Added amount | | Added amount | | amount |
| | polymer (A) | Type | weight | (parts) | Type | (parts) | Type | (parts) | Type | (parts) |
| Example 10 | Polymer A1 | *4 | 5000 | 0.02 | C/L | 0.45 | BPO | 0.1 | — | — |
| Example 11 | Polymer A1 | *4 | 5000 | 0.1 | C/L | 0.45 | BPO | 0.1 | — | — |
| Example 12 | Polymer A1 | *4 | 5000 | 0.5 | C/L | 0.45 | BPO | 0.1 | — | — |
| Example 13 | Polymer A1 | *4 | 5000 | 1 | C/L | 0.45 | BPO | 0.1 | — | — |
| Example 14 | Polymer A1 | *4 | 5000 | 3 | C/L | 0.45 | BPO | 0.1 | — | — |
| Example 15 | Polymer A1 | *4 | 5000 | 5 | C/L | 0.45 | BPO | 0.1 | — | — |
| Example 16 | Polymer A1 | *4 | 5000 | 10 | C/L | 0.45 | BPO | 0.1 | — | — |
| Example 17 | Polymer A1 | *5 | 14400 | 1 | C/L | 0.45 | BPO | 0.1 | — | — |
| Example 18 | Polymer A1 | *6 | 28300 | 1 | C/L | 0.45 | BPO | 0.1 | — | — |
| Example 19 | Polymer A1 | *2 | 19900 | 1 | C/L | 0.45 | BPO | 0.1 | — | — |
| Example 20 | Polymer A1 | *3 | 18100 | 1 | C/L | 0.45 | BPO | 0.1 | — | — |
| Example 21 | Polymer A1 | *1 | 15000 | 1 | C/L | 0.45 | BPO | 0.1 | — | — |
| Example 22 | Polymer A1 | *7 | 26700 | 1 | C/L | 0.45 | BPO | 0.1 | — | — |
| Example 23 | Polymer A1 | *4 | 5000 | 1 | C/L | 0.45 | BPO | 0.1 | KBM- | 0.2 |
| | | | | | | | | | 403 | |
| Example 24 | Polymer A1 | *4 | 5000 | 1 | C/L | 0.45 | — | — | — | — |
| Example 25 | Polymer A1 | *4 | 5000 | 25 | C/L | 0.45 | BPO | 0.1 | — | — |
| Comparative | Polymer A1 | — | — | — | C/L | 0.45 | BPO | 0.1 | — | — |
| Example 2 | | | | | | | | | | |
| Comparative | Polymer A1 | *8 | 27400 | 1 | C/L | 0.45 | BPO | 0.1 | — | — |
| Example 3 | | | | | | | | | | |
| Comparative | Polymer A1 | — | — | — | C/L | 0.45 | BPO | 0.1 | KBM- | 0.2 |
| Example 4 | | | | | | | | | 403 | |

| | Evaluation | | | | | | | | | |
|---|---|---|---|---|---|---|---|---|---|---|
| | Reworkability | | | | Durability | | | | | |
| | Initial stage | | After heating | | | | | Humidifying test | | |
| | Adhesive | | Adhesive | | Heating test | | | (500 H) | | |
| | strength | | strength | | (500 H) | | | 50° C./ | 65° C./ | Heat |
| | (N/25 mm) | Result | (N/25 mm) | Result | 80° C. | 100° C. | 110° C. | 90% RH | 90% RH | shock test |
| Example 10 | 6.0 | [symbol] | 15.0 | ◯ | [symbol] | [symbol] | ◯ | [symbol] | ◯ | [symbol] |
| Example 11 | 5.9 | [symbol] | 14.1 | ◯ | [symbol] | [symbol] | [symbol] | [symbol] | [symbol] | [symbol] |
| Example 12 | 5.5 | [symbol] | 10.0 | [symbol] | [symbol] | [symbol] | [symbol] | [symbol] | [symbol] | [symbol] |
| Example 13 | 5.0 | [symbol] | 9.0 | [symbol] | [symbol] | [symbol] | [symbol] | [symbol] | [symbol] | [symbol] |
| Example 14 | 4.9 | [symbol] | 11.5 | [symbol] | [symbol] | [symbol] | [symbol] | [symbol] | [symbol] | [symbol] |
| Example 15 | 4.6 | [symbol] | 12.5 | ◯ | [symbol] | [symbol] | [symbol] | [symbol] | [symbol] | [symbol] |
| Example 16 | 4.3 | [symbol] | 13.2 | ◯ | [symbol] | [symbol] | [symbol] | [symbol] | [symbol] | [symbol] |
| Example 17 | 7.2 | ◯ | 14.8 | ◯ | [symbol] | [symbol] | [symbol] | [symbol] | [symbol] | [symbol] |
| Example 18 | 8.9 | ◯ | 17.8 | Δ | [symbol] | [symbol] | [symbol] | [symbol] | [symbol] | [symbol] |
| Example 19 | 8.5 | ◯ | 15.8 | ◯ | [symbol] | [symbol] | [symbol] | [symbol] | [symbol] | [symbol] |
| Example 20 | 8.6 | ◯ | 15.9 | ◯ | [symbol] | [symbol] | [symbol] | [symbol] | [symbol] | [symbol] |
| Example 21 | 6.9 | [symbol] | 14.5 | ◯ | [symbol] | [symbol] | [symbol] | [symbol] | [symbol] | [symbol] |
| Example 22 | 6.5 | [symbol] | 13.5 | ◯ | [symbol] | [symbol] | [symbol] | [symbol] | [symbol] | [symbol] |
| Example 23 | 5.5 | [symbol] | 9.8 | [symbol] | [symbol] | [symbol] | [symbol] | [symbol] | [symbol] | [symbol] |
| Example 24 | 4.3 | [symbol] | 16.2 | ◯ | [symbol] | [symbol] | [symbol] | [symbol] | [symbol] | [symbol] |
| Example 25 | 4.0 | [symbol] | 13.0 | ◯ | ◯ | Δ | Δ | Δ | Δ | Δ |
| Comparative | 12.4 | Δ | 23.5 | X | ◯ | Δ | X | Δ | X | X |
| Example 2 | | | | | | | | | | |
| Comparative | 8.4 | ◯ | 18.9 | ◯ | ◯ | Δ | X | Δ | X | X |
| Example 3 | | | | | | | | | | |
| Comparative | 13.1 | X | 26.1 | X | ◯ | ◯ | ◯ | ◯ | ◯ | ◯ |
| Example 4 | | | | | | | | | | |

TABLE 3

| | Pressure-sensitive adhesive composition | | | | | | | | | |
|---|---|---|---|---|---|---|---|---|---|---|
| | | Polyether compound | | | | | | | Silane | |
| | | (B) | | | | | | | coupling | |
| | | | Number | | Crosslinking agent (C) | | | | agent (D) | |
| | Type of | | average | Added | Isocyanate | | Peroxide | | | Added |
| | acryl-based | | molecular | amount | | Added amount | | Added amount | | amount |
| | polymer (A) | Type | weight | (parts) | Type | (parts) | Type | (parts) | Type | (parts) |
| Example 26 | Polymer A2 | *4 | 5000 | 0.1 | C/L | 0.1 | BPO | 0.1 | — | — |
| Example 27 | Polymer A2 | *4 | 5000 | 0.1 | C/L | 0.45 | BPO | 0.1 | — | — |
| Example 28 | Polymer A2 | *4 | 5000 | 0.1 | D110N | 0.1 | BPO | 0.3 | — | — |
| Example 29 | Polymer A2 | *4 | 5000 | 1 | D110N | 0.1 | BPO | 0.3 | — | — |
| Example 30 | Polymer A2 | *4 | 5000 | 10 | D110N | 0.1 | BPO | 0.3 | — | — |
| Example 31 | Polymer A2 | *6 | 28300 | 1 | D110N | 0.1 | BPO | 0.3 | — | — |
| Example 32 | Polymer A2 | *4 | 5000 | 1 | D110N | 0.1 | BPO | 0.3 | KBM- | 0.2 |
| | | | | | | | | | 403 | |
| Example 33 | Polymer A2 | *4 | 5000 | 25 | C/L | 0.45 | BPO | 0.1 | — | — |
| Comparative | Polymer A2 | — | — | — | C/L | 0.45 | BPO | 0.1 | — | — |
| Example 5 | | | | | | | | | | |
| Comparative | Polymer A2 | *8 | 27400 | 1 | C/L | 0.45 | BPO | 0.1 | — | — |
| Example 6 | | | | | | | | | | |
| Comparative | Polymer A2 | — | — | — | D110N | 0.1 | BPO | 0.1 | — | — |
| Example 7 | | | | | | | | | | |

| | Evaluation | | | | | | | | | |
|---|---|---|---|---|---|---|---|---|---|---|
| | Reworkability | | | | Durability | | | | | |
| | Initial stage | | After heating | | | | | Humidifying test | | |
| | Adhesive | | Adhesive | | Heating test | | | (500 H) | | |
| | strength | | strength | | (500 H) | | | 60° C./ | 65° C./ | Heat |
| | (N/25 mm) | Result | (N/25 mm) | Result | 80° C. | 100° C. | 110° C. | 90% RH | 90% RH | shock test |
| Example 26 | 4.2 | [symbol] | 8.9 | [symbol] | [symbol] | ◯ | Δ | ◯ | Δ | ◯ |
| Example 27 | 3.9 | [symbol] | 9.0 | [symbol] | [symbol] | ◯ | Δ | ◯ | Δ | ◯ |
| Example 28 | 3.8 | [symbol] | 9.5 | [symbol] | [symbol] | ◯ | Δ | ◯ | Δ | ◯ |
| Example 29 | 3.6 | [symbol] | 7.0 | [symbol] | [symbol] | ◯ | Δ | ◯ | Δ | ◯ |
| Example 30 | 3.5 | [symbol] | 6.5 | [symbol] | [symbol] | ◯ | Δ | ◯ | Δ | ◯ |
| Example 31 | 5.1 | [symbol] | 10.8 | [symbol] | [symbol] | ◯ | Δ | ◯ | Δ | ◯ |
| Example 32 | 3.6 | [symbol] | 7.0 | [symbol] | [symbol] | ◯ | Δ | ◯ | Δ | ◯ |
| Example 33 | 3.1 | [symbol] | 6.0 | [symbol] | ◯ | Δ | X | Δ | X | Δ |
| Comparative | 6.1 | [symbol] | 12.4 | ◯ | ◯ | X | X | X | X | X |
| Example 5 | | | | | | | | | | |
| Comparative | 4.0 | [symbol] | 8.6 | [symbol] | ◯ | X | X | X | X | X |
| Example 6 | | | | | | | | | | |
| Comparative | 6.2 | [symbol] | 13.3 | ◯ | ◯ | X | X | X | X | X |
| Example 7 | | | | | | | | | | |

In the polyether compound (B) column of Tables 1 to 3, *1 represents the polyether compound (B1) prepared in Production Example 3, *2 Excestar 52420 manufactured by ASAHI GLASS CO., LTD., *3 Excestar 53430 manufactured by ASAHI GLASS CO., LTD., *4 Silyl SAT10 manufactured by Kaneka Corporation, *5 Silyl SAT350 manufactured by Kaneka Corporation, and *6 Silyl SAX220 manufactured by Kaneka Corporation, in which all of them are polyether compounds (B) having a reactive silyl group.

The polyether compounds (B) represented by *2 and *4 to *6 are each the compound represented by the formula (4) in which A² is —C₃H₈—, Z¹ is —C₃H₈—Z⁰, and the reactive silyl group (Z⁰—) is a dimethoxymethylsilyl group in which R¹, R², and R³ are all methyl groups. The polyether compound (B) represented by *3 is the compound represented by the formula (6) in which all Z³ moieties are —C₃H₈—Z⁰, and the reactive silyl group (Z⁰—) is a dimethoxymethylsilyl group.

The compound represented by *7 has the same structure as the polyether compound (B1) prepared in Production Example 3, except that it has a different number average molecular weight.

The mark *8 represents ACX022 manufactured by Kaneka Corporation, which is a compound having allyl groups at both terminals in place of —C₃H₈—Z⁰ in the structure represented by the formula (4).

In the crosslinking agent (C) column, C/L represents an isocyanate crosslinking agent (tolylene diisocyanate adduct of trimethylolpropane, Coronate L manufactured by Nippon Polyurethane Industry Co., Ltd.), and D110N represents an isocyanate crosslinking agent (trimethylolpropane xylylene diisocyanate, Takenate D110N manufactured by Mitsui Takeda Chemicals, Inc.).

In the crosslinking agent (C) column, BPO represents benzoyl peroxide (Nyper BMT, manufactured by NOF Corporation).

In the silane coupling agent column, KBM-403 represents KBM403 manufactured by Shin-Etsu Chemical Co., Ltd.

### Production Example 1′

### <Preparation of Acrylic Polymer (A1′)>

To a four-neck flask equipped with a stirring blade, a thermometer, a nitrogen gas introducing tube, and a condenser were added 86 parts of butyl acrylate, 13 parts of benzyl acrylate, 1 parts of 2-hydroxyethyl acrylate, 0.1 parts of 2,2′-azobisisobutyronitrile as a polymerization initiator, and 100 parts of ethyl acetate. Nitrogen gas was introduced to replace the air, while the mixture was gently stirred, and then a polymerization reaction was performed for 8 hours, while the temperature of the liquid in the flask was kept at about 55° C., so that a solution of an acrylic polymer (al) with a weight average molecular weight (Mw) of 2,200,000 was prepared.

### Production Examples 2′ to 13′ and Production Example 3

Solutions of acryl-based polymers (A2′) to (A13′) and an acryl-based polymer (A3) were prepared as in Production Example 1′, except that the type or content of the monomers used to form the acryl-based polymers was changed as shown in Table 4. The acryl-based polymers (A2′) to (A13′) and the acryl-based polymer (A3) each had a weight average molecular weight of 2,200,000.

TABLE 4

| | | | | | | | Weight |
|---|---|---|---|---|---|---|---|
| | | Monomer composition | | | | | average |
| | | (parts by weight) | | | | | molecular |
| | | BA | BzA | PEA | AA | HBA | weight |
| Production Example 1′ | Polymer A1′ | 86 | 13 | — | — | 1 | 2,200,000 |
| Production Example 2′ | Polymer A2′ | 82.1 | 13 | — | 4.8 | 0.1 | 2,200,000 |
| Production Example 3′ | Polymer A3′ | 82.1 | — | 13 | 4.8 | 0.1 | 2,200,000 |
| Production Example 4′ | Polymer A4′ | 35.1 | 60 | — | 4.8 | 0.1 | 2,200,000 |
| Production Example 5′ | Polymer A5′ | 45.1 | 50 | — | 4.8 | 0.1 | 2,200,000 |
| Production Example 6′ | Polymer A6′ | 60.1 | 35 | — | 4.8 | 0.1 | 2,200,000 |
| Production Example 7′ | Polymer A7′ | 75.1 | 20 | — | 4.8 | 0.1 | 2,200,000 |
| Production Example 8′ | Polymer A8′ | 77.1 | 18 | — | 4.8 | 0.1 | 2,200,000 |
| Production Example 9′ | Polymer A9′ | 79.1 | 16 | — | 4.8 | 0.1 | 2,200,000 |
| Production Example 10′ | Polymer A10′ | 85.1 | 10 | — | 4.8 | 0.1 | 2,200,000 |
| Production Example 11′ | Polymer A11′ | 88.1 | 7 | — | 4.8 | 0.1 | 2,200,000 |
| Production Example 12′ | Polymer A12′ | 91.1 | 4 | — | 4.8 | 0.1 | 2,200,000 |
| Production Example 13′ | Polymer A13′ | 94.1 | 1 | — | 4.8 | 0.1 | 2,200,000 |
| Production Example 3 | Polymer A3 | 95.1 | — | — | 4.8 | 0.1 | 2,200,000 |

In Table 4, BA represents butyl acrylate, BzA benzyl acrylate, PEA phenoxyethyl acrylate, HBA 4-hydroxybutyl acrylate, and AA acrylic acid.

### Example 1′

### (Preparation of Pressure-Sensitive Adhesive Composition)

Based on 100 parts of the solids of the acryl-based polymer (A1′) solution obtained in Production Example 1′, 1 part of Silyl SAX220 manufactured by Kaneka Corporation (the compound represented by the formula (4) in which A² is —C₃H₈—, Z¹ is —C₃H₈—Z⁰, and the reactive silyl group (Z⁰—) is a dimethoxymethylsilyl group in which R¹, R², and R³ are all methyl groups, and having a number average molecular weight of 5,000) as the polyether compound (B) having a reactive silyl group, 0.1 parts of an isocyanate crosslinking agent (tolylene diisocyanate adduct of trimethylolpropane, Coronate L manufactured by Nippon Polyurethane Industry Co., Ltd.), and 0.1 parts of benzoyl peroxide (Nyper BMT, manufactured by NOF Corporation) were added to the acryl-based polymer (A1′) solution, so that a solution (11% in solids content) of an acryl-based pressure-sensitive adhesive composition was prepared.

### (Formation of Pressure-Sensitive Adhesive Layer)

The acrylic pressure-sensitive adhesive solution was then applied to one side of a silicone-treated, 38 μm-thick, polyethylene terephthalate (PET) film (MRF38 manufactured by Mitsubishi Polyester Film Corporation) so that a 23 μm-thick pressure-sensitive adhesive layer could be formed after drying. The acrylic pressure-sensitive adhesive solution was then dried at 155° C. for 1 minute to form a pressure-sensitive adhesive layer.

### (Preparation of Pressure-Sensitive Adhesive Layer-Carrying Polarizing Plate)

An undercoat layer (100 nm in thickness) was formed by applying, with a wire bar, an undercoating agent to the transparent protective film side of each of the three polarizing plates, where a pressure-sensitive adhesive layer was to be formed. The undercoating agent used was prepared by diluting a thiophene polymer-containing solution (Denatron P521-AC (trade name) manufactured by Nagase ChemteX Corporation) with a mixture solution of water and isopropyl alcohol so that a solids content of 0.6% by weight could be obtained. Each of the pressure-sensitive adhesive layers was then transferred from the silicone-treated PET film to the undercoat layer, so that three pressure-sensitive adhesive layer-carrying polarizing plates were obtained.

### Examples 2′ to 26′, Example 34, and Comparative Examples 1 to 5′

Pressure-sensitive adhesive layer-carrying polarizing plates were prepared as in Example 1, except that the type of the acryl-based polymer (A′), the type or amount of the polyether compound (B) used (or the presence or absence thereof), and the type or amount of the crosslinking agent used were changed as shown in Table 5 and that the silane coupling agent was used in the ratio shown in Table 5.

The three pressure-sensitive adhesive layer-carrying polarizing plates (samples) obtained in the examples and the comparative examples were evaluated as described below. The results of the evaluation are shown in Table 5.

### <Corner Non-Uniformity>

Two pieces with a size of 420 mm (length)×320 mm (width) were prepared by cutting each sample. The samples were bonded with a laminator to both sides of a 0.07 mm-thick non-alkali glass plate in the crossed Nicols arrangement. The sample laminate was then autoclaved at 50° C. under 5 atm for 15 minutes to give a secondary sample (initial stage). The secondary sample was then treated under the condition of 90° C. for 24 hours (after heating). At the initial stage and after heating, the secondary sample was placed on a 10,000 candela backlight, and light leakage was visually evaluated according to the criteria below.

⊙: There is neither corner non-uniformity nor practical problem.
◯: Corner non-uniformity slightly occurs but does not occur in the display region, and therefore, there is no practical problem.
Δ: Corner non-uniformity slightly occurs in the display region, but there is no practical problem.
x: Corner non-uniformity significantly occurs in the display region to cause a practical problem.

### <Durability>

The sample was formed with a size of 37 inches and bonded to a 0.7 mm-thick non-alkali glass plate (1737 manufactured by Corning Incorporated) using a laminator. The sample was then autoclaved at 50° C. under 0.5 MPa for 15 minutes, so that it was completely bonded to the non-alkali glass plate. The autoclaved sample was heat-treated at 80° C. for 500 hours (heating test 1) or at 100° C. for 500 hours (heating test 2) or humidity-treated under an atmosphere at 60° C. and 90% RH for 500 hours (humidifying test); or subjected to 300 cycles of one hour in 85° C. and −40° C. environments (heat shock test). Thereafter, the appearance between the polarizing plate and the glass plate was visually evaluated according to the criteria below.

⊙: There is no change in the appearance, such as foaming, peeling or separation.
◯: Peeling or foaming is slightly observed at an end portion, but there is no practical problem.
Δ: Peeling or foaming is observed at an end portion, but there is no practical problem if the intended use is not special.
x: Remarkable peeling is observed at an end portion to cause a practical problem.

### <Reworkability>

The sample was cut into a piece of 25 mm (width)×100 mm (length), which was bonded to a 0.7 mm-thick non-alkali glass plate (1737 manufactured by Corning Incorporated) using a laminator. The sample was then autoclaved at 50° C. under 5 atm for 15 minutes, so that it was completely bonded to the glass plate (initial stage). Thereafter, the sample was heat-treated at 60° C. under dry conditions for 48 hours (after heating), and then, the adhesive strength of the sample piece was measured.

The sample was peeled from the glass plate at a peel angle of 90° and a peel rate of 300 mm/minute with a tensile tester (Autograph SHIMAZU AG-1 10KN), when the adhesive strength (N/25 mm, 80 m in length during the measurement) was measured. In the measurement, sampling was performed at an interval of 0.5 seconds for one measurement, and the average was used as the measured value.

The same sample piece as used in the measurement of the adhesive strength (except that the cut piece was 420 mm long by 320 mm wide) was peeled off from the non-alkali glass plate by hand, when the reworkability was evaluated according to the criteria below. Three sample pieces were prepared by the procedure described above, and the evaluation of the reworkability was repeated three times using them.

⊙: All of the three pieces were successfully peeled off without adhesive residue or breakage of the film.
◯: In some of the three pieces, the film was broken but peeled off by re-peeling.
Δ: In all of the three pieces, the film was broken but peeled off by re-peeling.
x: In all of the three pieces, an adhesive residue occurred, or the film was broken and failed to be peeled off even by repeated peeling.

TABLE 5

| | Pressure-sensitive adhesive composition | | | | | | | | | | | | | | | |
|---|---|---|---|---|---|---|---|---|---|---|---|---|---|---|---|---|
| | | | | | | | | | Silane | | | | | | | |
| | | | | | | | | | coupling | | Corner | | | | | |
| | | Polyether | | | Crosslinking agent (C) | | | | agent | | non-uniformity | | | | | |
| | Type of | compound (B) | | | | | Peroxide | | (D) | | | | | After heating | | |
| | acryl-based | | Number average | Added | Isocyanate | | | Added | | Added | Initial stage | | | | | Norbornene- |
| | polymer (A) | Type | molecular weight | amount | Type | Added amount | Type | amount | Type | amount | TAC-based | Acryl-based | Norbornene-based | TAC-based | Acryl-based | based |
| Example 1′ | Polymer A1′ | *4 | 5000 | 1 | C/L | 0.1 | BPO | 0.1 | — | — | [symbol] | [symbol] | [symbol] | [symbol] | [symbol] | [symbol] |
| Example 2′ | Polymer A1′ | *4 | 5000 | 1 | D110N | 0.1 | BPO | 0.1 | — | — | [symbol] | [symbol] | [symbol] | [symbol] | [symbol] | [symbol] |
| Example 3′ | Polymer A1′ | *4 | 5000 | 10 | D110N | 0.1 | BPO | 0.1 | — | — | [symbol] | [symbol] | [symbol] | [symbol] | [symbol] | [symbol] |
| Example 4′ | Polymer A1′ | *6 | 28300 | 1 | C/L | 0.1 | BPO | 0.1 | — | — | [symbol] | [symbol] | [symbol] | [symbol] | [symbol] | [symbol] |
| Example 5′ | Polymer A2′ | *4 | 5000 | 0.02 | C/L | 0.45 | BPO | 0.1 | — | — | [symbol] | [symbol] | [symbol] | [symbol] | [symbol] | [symbol] |
| Example 6′ | Polymer A2′ | *4 | 5000 | 0.1 | C/L | 0.45 | BPO | 0.1 | — | — | [symbol] | [symbol] | [symbol] | [symbol] | [symbol] | [symbol] |
| Example 7′ | Polymer A2′ | *4 | 5000 | 0.5 | C/L | 0.45 | BPO | 0.1 | — | — | [symbol] | [symbol] | [symbol] | [symbol] | [symbol] | [symbol] |
| Example 8′ | Polymer A2′ | *4 | 5000 | 1 | C/L | 0.45 | BPO | 0.1 | — | — | [symbol] | [symbol] | [symbol] | [symbol] | [symbol] | [symbol] |
| Example 9′ | Polymer A2′ | *4 | 5000 | 3 | C/L | 0.45 | BPO | 0.1 | — | — | [symbol] | [symbol] | [symbol] | [symbol] | [symbol] | [symbol] |
| Example 10′ | Polymer A2′ | *4 | 5000 | 5 | C/L | 0.45 | BPO | 0.1 | — | — | [symbol] | [symbol] | [symbol] | [symbol] | [symbol] | [symbol] |
| Example 11′ | Polymer A2′ | *4 | 5000 | 10 | C/L | 0.45 | BPO | 0.1 | — | — | [symbol] | [symbol] | [symbol] | [symbol] | [symbol] | [symbol] |
| Example 12′ | Polymer A2′ | *4 | 5000 | 1 | C/L | 0.45 | BPO | 0.1 | KBM- | 0.2 | [symbol] | [symbol] | [symbol] | [symbol] | [symbol] | [symbol] |
| | | | | | | | | | 403 | | | | | | | |
| Example 13′ | Polymer A2′ | *6 | 28300 | 1 | C/L | 0.45 | BPO | 0.1 | — | — | [symbol] | [symbol] | [symbol] | [symbol] | [symbol] | [symbol] |
| Example 14′ | Polymer A1′ | *4 | 5000 | 25 | C/L | 0.1 | BPO | 0.1 | — | — | [symbol] | [symbol] | [symbol] | [symbol] | [symbol] | [symbol] |
| Example 15′ | Polymer A2′ | *4 | 5000 | 25 | C/L | 0.45 | BPO | 0.1 | — | — | [symbol] | [symbol] | [symbol] | [symbol] | [symbol] | [symbol] |
| Example 16′ | Polymer A3′ | *4 | 5000 | 1 | C/L | 0.45 | BPO | 0.1 | — | — | [symbol] | [symbol] | [symbol] | [symbol] | [symbol] | [symbol] |
| Example 17′ | Polymer A4′ | *4 | 5000 | 1 | C/L | 0.45 | BPO | 0.1 | — | — | [symbol] | [symbol] | [symbol] | Δ | Δ | Δ |
| Example 18′ | Polymer A5′ | *4 | 5000 | 1 | C/L | 0.45 | BPO | 0.1 | — | — | [symbol] | [symbol] | [symbol] | Δ | Δ | Δ |
| Example 19′ | Polymer A6′ | *4 | 5000 | 1 | C/L | 0.45 | BPO | 0.1 | — | — | [symbol] | [symbol] | [symbol] | Δ | Δ | Δ |
| Example 20′ | Polymer A7′ | *4 | 5000 | 1 | C/L | 0.45 | BPO | 0.1 | — | — | [symbol] | [symbol] | [symbol] | ◯ | ◯ | [symbol] |
| Example 21′ | Polymer A8′ | *4 | 5000 | 1 | C/L | 0.45 | BPO | 0.1 | — | — | [symbol] | [symbol] | [symbol] | ◯ | [symbol] | [symbol] |
| Example 22′ | Polymer A9′ | *4 | 5000 | 1 | C/L | 0.45 | BPO | 0.1 | — | — | [symbol] | [symbol] | [symbol] | [symbol] | [symbol] | [symbol] |
| Example 23′ | Polymer | *4 | 5000 | 1 | C/L | 0.45 | BPO | 0.1 | — | — | [symbol] | [symbol] | [symbol] | [symbol] | [symbol] | [symbol] |
| | A10′ | | | | | | | | | | | | | | | |
| Example 24′ | Polymer | *4 | 5000 | 1 | C/L | 0.45 | BPO | 0.1 | — | — | [symbol] | [symbol] | [symbol] | [symbol] | ◯ | [symbol] |
| | A11′ | | | | | | | | | | | | | | | |
| Example 25′ | Polymer | *4 | 5000 | 1 | C/L | 0.45 | BPO | 0.1 | — | — | [symbol] | [symbol] | [symbol] | [symbol] | ◯ | ◯ |
| | A12′ | | | | | | | | | | | | | | | |
| Example 26′ | Polymer | *4 | 5000 | 1 | C/L | 0.45 | BPO | 0.1 | — | — | [symbol] | [symbol] | [symbol] | [symbol] | Δ | ◯ |
| | A13′ | | | | | | | | | | | | | | | |
| Comparative | Polymer A1′ | — | — | — | C/L | 0.1 | BPO | 0.1 | — | — | [symbol] | [symbol] | [symbol] | [symbol] | [symbol] | [symbol] |
| Example 1′ | | | | | | | | | | | | | | | | |
| Comparative | Polymer A1′ | *8 | 27400 | 1 | C/L | 0.1 | BPO | 0.1 | — | — | [symbol] | [symbol] | [symbol] | [symbol] | [symbol] | [symbol] |
| Example 2′ | | | | | | | | | | | | | | | | |
| Comparative | Polymer A1′ | — | — | — | D110N | 0.1 | BPO | 0.1 | — | — | [symbol] | [symbol] | [symbol] | [symbol] | [symbol] | [symbol] |
| Example 3′ | | | | | | | | | | | | | | | | |
| Comparative | Polymer A2′ | — | — | — | C/L | 0.45 | BPO | 0.1 | — | — | [symbol] | [symbol] | [symbol] | [symbol] | [symbol] | [symbol] |
| Example 4′ | | | | | | | | | | | | | | | | |
| Comparative | Polymer A2′ | *8 | 27400 | 1 | C/L | 0.45 | BPO | 0.1 | — | — | [symbol] | [symbol] | [symbol] | [symbol] | [symbol] | [symbol] |
| Example 5′ | | | | | | | | | | | | | | | | |
| Example 34 | Polymer A3 | *4 | 5000 | 1 | C/L | 0.45 | BPO | 0.1 | — | — | [symbol] | [symbol] | [symbol] | X | X | X |

| | | | | | | | | | | | | | Reworkability | | | |
|---|---|---|---|---|---|---|---|---|---|---|---|---|---|---|---|---|
| | Durability | | | | | | | | | | | | Initial stage | | After heating | |
| | TAC-based | | | | Acryl-based | | | | Norbornene-based | | | | Adhesive | | Adhesive | |
| | Heating | Heating | Humidifying | Heat | Heating | Heating test | Humidifying | Heat shock | Heating | Heating test | Humidifying | Heat shock | strength | | strength | |
| | test 1 | test 2 | test | shock test | test 1 | 2 | test | test | test 1 | 2 | test | test | (N/25 mm) | Evaluation | (N/25 mm) | Evaluation |
| Example 1′ | [symbol] | ◯ | Δ | ◯ | [symbol] | ◯ | Δ | ◯ | [symbol] | ◯ | Δ | ◯ | 3.8 | [symbol] | 4.5 | [symbol] |
| Example 2′ | [symbol] | ◯ | Δ | ◯ | [symbol] | ◯ | Δ | ◯ | [symbol] | ◯ | Δ | ◯ | 3.7 | [symbol] | 4.7 | [symbol] |
| Example 3′ | [symbol] | ◯ | Δ | ◯ | [symbol] | ◯ | Δ | ◯ | [symbol] | ◯ | Δ | ◯ | 3.2 | [symbol] | 4.2 | [symbol] |
| Example 4′ | [symbol] | ◯ | Δ | ◯ | [symbol] | ◯ | Δ | ◯ | [symbol] | ◯ | Δ | ◯ | 4.5 | [symbol] | 6.5 | [symbol] |
| Example 5′ | [symbol] | [symbol] | ◯ | [symbol] | [symbol] | [symbol] | ◯ | [symbol] | [symbol] | ◯ | ◯ | [symbol] | 6 | [symbol] | 11.8 | ◯ |
| Example 6′ | [symbol] | [symbol] | [symbol] | [symbol] | [symbol] | [symbol] | [symbol] | [symbol] | [symbol] | ◯ | [symbol] | [symbol] | 5.9 | [symbol] | 10.3 | ◯ |
| Example 7′ | [symbol] | [symbol] | [symbol] | [symbol] | [symbol] | [symbol] | [symbol] | [symbol] | [symbol] | ◯ | [symbol] | [symbol] | 5.5 | [symbol] | 8.2 | [symbol] |
| Example 8′ | [symbol] | [symbol] | [symbol] | [symbol] | [symbol] | [symbol] | [symbol] | [symbol] | [symbol] | ◯ | [symbol] | [symbol] | 5 | [symbol] | 7.5 | [symbol] |
| Example 9′ | [symbol] | [symbol] | [symbol] | [symbol] | [symbol] | [symbol] | [symbol] | [symbol] | [symbol] | ◯ | [symbol] | [symbol] | 4.9 | [symbol] | 7.3 | [symbol] |
| Example 10′ | [symbol] | [symbol] | [symbol] | [symbol] | [symbol] | [symbol] | [symbol] | [symbol] | [symbol] | ◯ | [symbol] | [symbol] | 4.6 | [symbol] | 6.9 | [symbol] |
| Example 11′ | [symbol] | [symbol] | [symbol] | [symbol] | [symbol] | [symbol] | [symbol] | [symbol] | [symbol] | ◯ | [symbol] | [symbol] | 4.3 | [symbol] | 6.9 | [symbol] |
| Example 12′ | [symbol] | [symbol] | [symbol] | [symbol] | [symbol] | [symbol] | [symbol] | [symbol] | [symbol] | ◯ | [symbol] | [symbol] | 4.2 | [symbol] | 12.5 | Δ |
| Example 13′ | [symbol] | [symbol] | [symbol] | [symbol] | [symbol] | [symbol] | [symbol] | [symbol] | [symbol] | ◯ | [symbol] | [symbol] | 8.9 | ◯ | 13 | Δ |
| Example 14′ | [symbol] | ◯ | Δ | ◯ | [symbol] | ◯ | Δ | ◯ | ◯ | Δ | Δ | ◯ | 3 | [symbol] | 3.9 | [symbol] |
| Example 15′ | [symbol] | [symbol] | ◯ | ◯ | [symbol] | [symbol] | ◯ | ◯ | ◯ | ◯ | ◯ | ◯ | 4.1 | [symbol] | 6.5 | [symbol] |
| Example 16′ | [symbol] | [symbol] | ◯ | ◯ | [symbol] | [symbol] | ◯ | ◯ | [symbol] | ◯ | Δ | ◯ | 5.3 | [symbol] | 7.3 | [symbol] |
| Example 17′ | [symbol] | ◯ | Δ | ◯ | [symbol] | ◯ | Δ | ◯ | ◯ | ◯ | Δ | ◯ | 6.1 | [symbol] | 10.1 | ◯ |
| Example 18′ | [symbol] | ◯ | ◯ | [symbol] | [symbol] | ◯ | ◯ | [symbol] | ◯ | ◯ | ◯ | [symbol] | 5.7 | [symbol] | 9.2 | ◯ |
| Example 19′ | [symbol] | [symbol] | [symbol] | [symbol] | [symbol] | [symbol] | [symbol] | [symbol] | [symbol] | ◯ | [symbol] | [symbol] | 5.3 | [symbol] | 7.6 | [symbol] |
| Example 20′ | [symbol] | [symbol] | [symbol] | [symbol] | [symbol] | [symbol] | [symbol] | [symbol] | [symbol] | ◯ | [symbol] | [symbol] | 4.9 | [symbol] | 7.6 | [symbol] |
| Example 21′ | [symbol] | [symbol] | [symbol] | [symbol] | [symbol] | [symbol] | [symbol] | [symbol] | [symbol] | ◯ | [symbol] | [symbol] | 5.3 | [symbol] | 7.2 | [symbol] |
| Example 22′ | [symbol] | [symbol] | [symbol] | [symbol] | [symbol] | [symbol] | [symbol] | [symbol] | [symbol] | ◯ | [symbol] | [symbol] | 5.4 | [symbol] | 7 | [symbol] |
| Example 23′ | [symbol] | [symbol] | [symbol] | [symbol] | [symbol] | [symbol] | [symbol] | [symbol] | [symbol] | ◯ | [symbol] | [symbol] | 4.9 | [symbol] | 7.6 | [symbol] |
| Example 24′ | [symbol] | [symbol] | [symbol] | [symbol] | [symbol] | [symbol] | [symbol] | [symbol] | [symbol] | ◯ | [symbol] | [symbol] | 5 | [symbol] | 7.1 | [symbol] |
| Example 25′ | [symbol] | [symbol] | [symbol] | [symbol] | [symbol] | [symbol] | [symbol] | [symbol] | [symbol] | ◯ | [symbol] | [symbol] | 5.3 | [symbol] | 7.4 | [symbol] |
| Example 26′ | [symbol] | [symbol] | [symbol] | [symbol] | [symbol] | [symbol] | [symbol] | [symbol] | [symbol] | ◯ | [symbol] | [symbol] | 4.9 | [symbol] | 7.1 | [symbol] |
| Comparative | ◯ | X | Δ | X | ◯ | X | Δ | X | Δ | X | Δ | X | 5.5 | [symbol] | 8.4 | ◯ |
| Example 1′ | | | | | | | | | | | | | | | | |
| Comparative | ◯ | X | Δ | X | ◯ | X | Δ | X | Δ | X | Δ | X | 4.9 | [symbol] | 7 | [symbol] |
| Example 2′ | | | | | | | | | | | | | | | | |
| Comparative | ◯ | X | Δ | X | ◯ | X | Δ | X | Δ | X | Δ | X | 5.4 | [symbol] | 8.2 | ◯ |
| Example 3′ | | | | | | | | | | | | | | | | |
| Comparative | [symbol] | ◯ | ◯ | [symbol] | [symbol] | ◯ | ◯ | [symbol] | ◯ | Δ | ◯ | [symbol] | 9.6 | ◯ | 16.8 | X |
| Example 4′ | | | | | | | | | | | | | | | | |
| Comparative | [symbol] | ◯ | ◯ | [symbol] | [symbol] | ◯ | ◯ | [symbol] | ◯ | Δ | ◯ | [symbol] | 9.6 | ◯ | 15.2 | X |
| Example 5′ | | | | | | | | | | | | | | | | |
| Example 34 | [symbol] | [symbol] | [symbol] | [symbol] | [symbol] | [symbol] | [symbol] | [symbol] | [symbol] | ◯ | [symbol] | [symbol] | 5 | [symbol] | 6.9 | [symbol] |

In the polyether compound (B) column of Table 5, *4 represents Silyl SAT10 manufactured by Kaneka Corporation, and *6 represents Silyl SAX220 manufactured by Kaneka Corporation, in which all of them are polyether compounds (B) having a reactive silyl group.

The polyether compounds (B) represented by *4 and *6 are each the compound represented by the formula (4) in which A² is —C₃H₈—, Z¹ is —C₃H₈—Z⁰, and the reactive silyl group (Z⁰—) is a dimethoxymethylsilyl group in which R¹, R², and R³ are all methyl groups. SAX220 is the compound represented by the formula (6) in which all Z³ moieties are —C₃H₈—Z⁰, and the reactive silyl group (Z⁰—) is a dimethoxymethylsilyl group.

The mark *8 represents ACX022 manufactured by Kaneka Corporation, which is a compound having allyl groups at both terminals in place of —C₃H₈—Z⁰ in the structure represented by the formula (4).

In the crosslinking agent (C) column, C/L represents an isocyanate crosslinking agent (tolylene diisocyanate adduct of trimethylolpropane, Coronate L manufactured by Nippon Polyurethane Industry Co., Ltd.), and D110N represents an isocyanate crosslinking agent (trimethylolpropane xylylene diisocyanate, Takenate D110N manufactured by Mitsui Takeda Chemicals, Inc.).

In the crosslinking agent (C) column, BPO represents benzoyl peroxide (Nyper BMT, manufactured by NOF Corporation).

In the silane coupling agent column, KBM-403 represents KBM403 manufactured by Shin-Etsu Chemical Co., Ltd.

1. A pressure-sensitive adhesive composition for an optical film, comprising:
a (meth)acryl-based polymer (A): and
a polyether compound (B) having a polyether skeleton and a reactive silyl group represented by formula (1): —SiRₐM₃₋ₐ, at at least one terminal,
wherein R represents a monovalent organic group having 1 to 20 carbon atoms and optionally having a substituent; M represents a hydroxyl group or a hydrolyzable group; and <a> represents an integer of 0 to 2, provided that in cases where two or more R groups, R groups is the same or different, and in cases where two or more M groups, M groups is the same or different.

2. The pressure-sensitive adhesive composition for an optical film according to claim 1, wherein the polyether skeleton of the polyether compound (B) comprises a straight- or branched-chain oxyalkylene group of 1 to 10 carbon atoms as a repeating structural unit.

3. The pressure-sensitive adhesive composition for an optical film according to claim 2, wherein the polyether compound (B) is a compound represented by formula (2): RₐM₃₋ₐSi—X—Y-(AO)ₙ—Z,
wherein R represents a monovalent organic group having 1 to 20 carbon atoms and optionally having a substituent; M represents a hydroxyl group or a hydrolyzable group; <a> represents an integer of 0 to 2, provided that in cases where two or more R groups, R groups is the same or different, and in cases where two or more M groups, M groups is the same or different; AO represents a straight- or branched-chain oxyalkylene group of 1 to 10 carbon atoms; n represents the average addition molar number of the oxyalkylene groups, which is from 1 to 1,700; X represents a straight- or branched-chain alkylene group of 1 to 20 carbon atoms; Y represents an ether bond, an ester bond, a urethane bond, or a carbonate bond and
Z represents a hydrogen atom, a monovalent hydrocarbon group of 1 to 10 carbon atoms,
a group represented by formula (2A): —Y¹—X—SiRₐM₃₋ₐ,
wherein R, M and X have the same meanings as defined above; and Y¹ represents a single bond, a —CO— bond, a —CONH— bond, or a —COO— bond, or
a group represented by formula (2B): -Q{-(OA)ₙ-Y—X—SiRₐM₃₋ₐ}ₘ,
wherein R, M, X, and Y have the same meanings as defined above, OA has the same meaning as AO defined above, n has the same meaning as defined above, Q represents a divalent or polyvalent hydrocarbon group of 1 to 10 carbon atoms, and m represents a number that is the same as the valence of the hydrocarbon group.

4. The pressure-sensitive adhesive composition for an optical film according to claim 1, wherein the reactive silyl group of the polyether compound (B) is an alkoxysilyl group represented by formula (3): 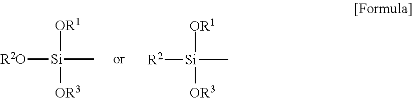
wherein R¹, R² and R³ each represent a monovalent hydrocarbon group of 1 to 6 carbon atoms and is the same or different in the same molecule.

5. The pressure-sensitive adhesive composition for an optical film according to claim 3, wherein the polyether compound (B) is a compound represented by formula (4): Z⁰-A²-O-(A¹O)ₙ—Z¹,
wherein A¹O represents an oxyalkylene group of 2 to 6 carbon atoms; n represents the average addition molar number of A¹O, which is from 1 to 1,700; Z¹ represents a hydrogen atom or -A²-Z⁰; and A² represents an alkylene group of 2 to 6 carbon atoms,
wherein Z⁰ represents an alkoxysilyl group represented by formula (3): 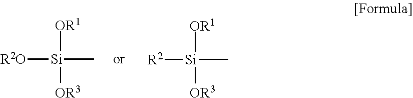
wherein R¹, R² and R³ each represent a monovalent hydrocarbon group of 1 to 6 carbon atoms and is the same or different in the same molecule.

6. The pressure-sensitive adhesive composition for an optical film according to claim 3, wherein the polyether compound (B) is a compound represented by formula (5): Z⁰-A²-NHCOO-(A¹O)ₙ—Z²,
wherein A¹O represents an oxyalkylene group of 2 to 6 carbon atoms; n represents the average addition molar number of A¹O, which is from 1 to 1,700; Z² represents a hydrogen atom or —CONH-A²-Z⁰; and A² represents an alkylene group of 2 to 6 carbon atoms,
wherein Z⁰ represents an alkoxysilyl group represented by formula (3): 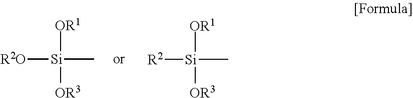
wherein R¹, R² and R³ each represent a monovalent hydrocarbon group of 1 to 6 carbon atoms and is the same or different in the same molecule.

7. The pressure-sensitive adhesive composition for an optical film according to claim 3, wherein the polyether compound (B) is a compound represented by formula (6): Z³—O-(A¹O)ₙ—CH{—CH₂-(A¹O)ₙ—Z³}₂,
wherein A¹O represents an oxyalkylene group of 2 to 6 carbon atoms; n represents the average addition molar number of A¹O, which is from 1 to 1,700; Z³ represents a hydrogen atom or -A²-Z⁰ and at least one of the Z³ groups is -A²-Z⁰, and A² represents an alkylene group of 2 to 6 carbon atoms,
wherein Z⁰ represents is an alkoxysilyl group represented by formula (3): 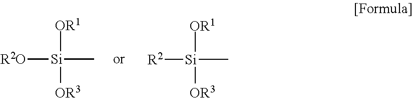
wherein R¹, R² and R³ each represent a monovalent hydrocarbon group of 1 to 6 carbon atoms and is the same or different in the same molecule.

8. The pressure-sensitive adhesive composition for an optical film according to claim 1, wherein the polyether compound (B) has a number average molecular weight of 300 to 100,000.

9. The pressure-sensitive adhesive composition for an optical film according to claim 1, which comprises 0.001 to 20 parts by weight of the polyether compound (B) based on 100 parts by weight of the (meth)acryl-based polymer (A).

10. The pressure-sensitive adhesive composition for an optical film according to claim 1, wherein the (meth)acryl-based polymer (A) comprises an alkyl (meth)acrylate monomer unit and a hydroxyl group-containing monomer unit.

11. The pressure-sensitive adhesive composition for an optical film according to claim 1, wherein the (meth)acryl-based polymer (A) comprises an alkyl (meth)acrylate monomer unit and a carboxyl group-containing monomer unit.

12. The pressure-sensitive adhesive composition for an optical film according to claim 1, wherein the (meth)acryl-based polymer (A) is a (meth)acryl-based polymer (A′) comprising an alkyl (meth)acrylate monomer unit and a polymerizable aromatic ring-containing monomer unit.

13. The pressure-sensitive adhesive composition for an optical film according to claim 12, wherein the (meth)acryl-based polymer (A′) comprises 1 to 50% by weight of the polymerizable aromatic ring-containing monomer unit.

14. The pressure-sensitive adhesive composition for an optical film according to claim 12, wherein the (meth)acryl-based polymer (A′) further comprises a hydroxyl group-containing monomer unit.

15. The pressure-sensitive adhesive composition for an optical film according to claim 12, wherein the (meth)acryl-based polymer (A′) further comprises a carboxyl group-containing monomer unit.

16. The pressure-sensitive adhesive composition for an optical film according to claim 12, further comprising a crosslinking agent.

17. The pressure-sensitive adhesive composition for an optical film according to claim 16, which comprises 0.01 to 20 parts by weight of the crosslinking agent (C) based on 100 parts by weight of the (meth)acryl-based polymer (A).

18. The pressure-sensitive adhesive composition for an optical film according to claim 16, wherein the crosslinking agent (C) is at least one selected from an isocyanate compound and a peroxide.

19. The pressure-sensitive adhesive composition for an optical film according to claim 1, further comprising 0.001 to 5 parts by weight of a silane coupling agent (D) based on 100 parts by weight of the (meth)acryl-based polymer (A).

20. The pressure-sensitive adhesive composition for an optical film according to claim 1, wherein the (meth)acryl-based polymer (A) has a weight average molecular weight of 500,000 to 4,000,000.

21. A pressure-sensitive adhesive layer for an optical film, comprising a product formed from the pressure-sensitive adhesive composition for an optical film according to claim 1.

22. A pressure-sensitive adhesive optical film, comprising an optical film; and the pressure-sensitive adhesive layer for an optical film according to claim 21 formed on at least one side of the optical film.

23. The pressure-sensitive adhesive optical film according to claim 22, further comprising an adhesion-facilitating layer that is provided between the optical film and the pressure-sensitive adhesive layer for an optical film.

24. An image display, comprising at least one piece of the pressure-sensitive adhesive optical film according to claim 22.
